(19) United States
(12) Patent Application Publication
(10) Pub. No.: US 2025/0374295 A1
(43) Pub. Date: Dec. 4, 2025

(54) PHYSICAL DOWNLINK CONTROL CHANNEL (PDCCH) BLIND DETECTION PROCEDURE WITH CONFIGURABLE NUMBER OF DOWNLINK CONTROL INFORMATION (DCI) SIZES

(71) Applicant: QUALCOMM Incorporated, San Diego, CA (US)

(72) Inventors: Mahmoud TAHERZADEH BOROUJENI, San Diego, CA (US); Mostafa KHOSHNEVISAN, San Diego, CA (US); Wei YANG, San Diego, CA (US); Gabi SARKIS, San Diego, CA (US)

(21) Appl. No.: 18/732,354

(22) Filed: Jun. 3, 2024

(51) Int. Cl. H04W 72/232; H04W 52/02; H04W 72/51

(52) U.S. Cl. CPC H04W 72/232; H04W 52/0229; H04W 72/51

(57) ABSTRACT

Various aspects of the present disclosure generally relate to wireless communication, and to a physical downlink control channel (PDCCH) blind detection procedure with a configurable number of downlink control information (DCI) sizes. For example, a user equipment (UE) identifies a DCI size limit related to a PDCCH blind detection mode or a total number of PDCCH candidates to be monitored. The DCI size limit may be preprogrammed at the UE, such as with a value specified by a wireless communication standard, or signaled by a network node. In accordance with identifying the DCI size limit, the UE performs blind detection operations on a set of PDCCH candidates in which the UE monitors each of a set of candidate DCI sizes within the DCI size limit. Successful performance of the blind detection operations may identify a PDCCH candidate that includes control information from the network node.

### FIELD OF THE DISCLOSURE

Aspects of the present disclosure relate generally to wireless communication systems, and more particularly, to a physical downlink control channel (PDCCH) blind detection procedure with a configurable number of downlink control information (DCI) sizes in wireless communication systems.

### BACKGROUND

Wireless communications systems are widely deployed to provide various types of services such as voice, video, packet data, messaging, broadcast, and other types of traffic. The services may include unicast, multicast, and/or broadcast services, among other examples. Typical wireless communication systems may support multiple-access radio access technologies and include a number of base stations or network nodes, each supporting communication for multiple communication devices, which may be otherwise known as user equipment (UE). These systems may be capable of supporting communication with multiple users by sharing available system resources (such as time domain resources, frequency domain resources, spatial domain resources, and device transmit power, among other examples). These systems may employ multiple-access technologies such as code division multiple access (CDMA) technology, time division multiple access (TDMA) technology, frequency division multiple access (FDMA) technology, orthogonal frequency division multiple access (OFDMA) technology, discrete Fourier transform spread orthogonal frequency division multiplexing (DFT-S-OFDM) technology, single-carrier frequency division multiple access (SC-FDMA) technology, and time division synchronous code division multiple access (TD-SCDMA) technology.

The above multiple-access technologies have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, carrier aggregation, high-precision positioning, and/or radio frequency (RF) sensing, among other examples. As the demand for mobile broadband access continues to increase, further improvements in NR may be implemented, and other radio access technologies, such as 6G, may be introduced to further advance mobile broadband evolution.

To support data communication or services in a wireless communication system, a network node may send control information to a UE to indicate a wireless channel via which the UE is to receive downlink data or a service from the network node. For example, a network node, such as a base station, may send downlink control information (DCI) to the UE to indicate the wireless channel. This DCI is carried in a physical downlink control channel (PDCCH), which represents an area in a search space (i.e., wireless resources in a resource grid) where the UE is to monitor to receive the DCI via the PDCCH. Because some DCI can be communicated before an initiation process for a communication link between the UE and the network node is completed, the UE may perform a PDCCH blind detection procedure on one or more PDCCH candidates in various monitoring occasions and over various control resource sets (CORESETS) to search for the PDCCH. As part of the PDCCH blind detection procedure, the UE performs channel estimation and then attempts to fully decode each candidate PDCCH using a location, structure, and scrambling code to determine if a cyclic redundancy check (CRC) portion of the candidate PDCCH is capable of being unscrambled using an identifier associated with the UE.

In order to increase flexibility of the transmission of control information by the network node, DCI contained within a PDCCH may have one of various sizes, referred to as a DCI size. Increasing the number of candidate DCI sizes that are monitored by a UE can increase the complexity of the PDCCH blind decoding procedure. For example, a separate blind detection operation may be performed by the UE on a particular PDCCH candidate for each of the candidate DCI sizes. Because a total number of PDCCH blind detection operations can be limited in 5G NR wireless communication systems, a small number of candidate DCI sizes are typically monitored by the UE to enable blind detection operations to be performed on a sufficient number of PDCCH candidates without exceeding a PDCCH blind detection limit. However, DCI generated by a network node often has a size that does not match one of the limited number of candidate DCI sizes. In such situations, the network node may increase the size of the DCI, such as via zero padding, or decrease the size, such as via truncation, to fit the DCI into one of the candidate DCI sizes. Artificially increasing or decreasing the size of DCI can reduce the available bandwidth or throughput of the wireless network, and can sometimes require a higher coding rate for the DCI, which may degrade performance of the wireless network.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Some aspects described herein relate to a user equipment (UE) for wireless communication. The UE includes a processing system that includes one or more processors and one or more memories coupled with the one or more processors. The processing system is configured to cause the UE to identify a downlink control information (DCI) size limit associated with a total number of physical downlink control channel (PDCCH) candidates of a set of PDCCH candidates, a PDCCH blind detection mode of a set of PDCCH blind detection modes, or a combination thereof. The processing system is also configured to cause the UE to perform, for each PDCCH candidate of the set of PDCCH candidates, and for each candidate DCI size of a set of candidate DCI sizes within the identified DCI size limit, a blind detection operation on the PDCCH candidate. The processing system is further configured to cause the UE to receive, from a network node, control information via a PDCCH candidate of the set of PDCCH candidates in accordance with the performance of the blind detection operation on the PDCCH candidate.

Some aspects described herein relate to a method of wireless communication performed by a UE. The method includes identifying a DCI size limit associated with a total number of PDCCH candidates of a set of PDCCH candidates, a PDCCH blind detection mode of a set of PDCCH blind detection modes, or a combination thereof. The method also includes performing, for each PDCCH candidate of the set of PDCCH candidates, and for each candidate DCI size of a set of candidate DCI sizes within the identified DCI size limit, a blind detection operation on the PDCCH candidate. The method further includes receiving, from a network node, control information via a PDCCH candidate of the set of PDCCH candidates in accordance with the performance of the blind detection operation on the PDCCH candidate.

Some aspects described herein relate to an apparatus. The apparatus includes means for identifying a DCI size limit associated with a total number of PDCCH candidates of a set of PDCCH candidates, a PDCCH blind detection mode of a set of PDCCH blind detection modes, or a combination thereof. The apparatus also includes means for performing, for each PDCCH candidate of the set of PDCCH candidates, and for each candidate DCI size of a set of candidate DCI sizes within the identified DCI size limit, a blind detection operation on the PDCCH candidate. The apparatus further includes means for receiving, from a network node, control information via a PDCCH candidate of the set of PDCCH candidates in accordance with the performance of the blind detection operation on the PDCCH candidate.

Some aspects described herein relate to a non-transitory computer-readable medium that stores instructions that, when executed by one or more processors, cause the one or more processors to perform operations. The operations include identifying a DCI size limit associated with a total number of PDCCH candidates of a set of PDCCH candidates, a PDCCH blind detection mode of a set of PDCCH blind detection modes, or a combination thereof. The operations also include performing, for each PDCCH candidate of the set of PDCCH candidates, and for each candidate DCI size of a set of candidate DCI sizes within the identified DCI size limit, a blind detection operation on the PDCCH candidate. The operations further include receiving, from a network node, control information via a PDCCH candidate of the set of PDCCH candidates in accordance with the performance of the blind detection operation on the PDCCH candidate.

Some aspects described herein relate to a network node for wireless communication. The network node includes a processing system that includes one or more processors and one or more memories coupled with the one or more processors. The processing system is configured to cause the network node to select, from a set of candidate DCI sizes within a DCI size limit, a DCI size. The DCI size limit is associated with a total number of PDCCH candidates of a set of PDCCH candidates, a PDCCH blind detection mode of a set of PDCCH blind detection modes, or a combination thereof. The processing system is further configured to cause the network node to transmit, to a UE, control information via a PDCCH from the set of PDCCH candidates in accordance with the selected DCI size.

Some aspects described herein relate to a method of wireless communication performed by a network node. The method includes selecting, from a set of candidate DCI sizes within a DCI size limit, a DCI size. The DCI size limit is associated with a total number of PDCCH candidates of a set of PDCCH candidates, a PDCCH blind detection mode of a set of PDCCH blind detection modes, or a combination thereof. The method further includes transmitting, to a UE, control information via a PDCCH from the set of PDCCH candidates in accordance with the selected DCI size.

Some aspects described herein relate to an apparatus. The apparatus includes means for selecting, from a set of candidate DCI sizes within a DCI size limit, a DCI size. The DCI size limit is associated with a total number of PDCCH candidates of a set of PDCCH candidates, a PDCCH blind detection mode of a set of PDCCH blind detection modes, or a combination thereof. The apparatus further includes means for transmitting, to a UE, control information via a PDCCH from the set of PDCCH candidates in accordance with the selected DCI size.

Some aspects described herein relate to a non-transitory computer-readable medium that stores instructions that, when executed by one or more processors, cause the one or more processors to perform operations. The operations include selecting, from a set of candidate DCI sizes within a DCI size limit, a DCI size. The DCI size limit is associated with a total number of PDCCH candidates of a set of PDCCH candidates, a PDCCH blind detection mode of a set of PDCCH blind detection modes, or a combination thereof. The operations further include transmitting, to a UE, control information via a PDCCH from the set of PDCCH candidates in accordance with the selected DCI size.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, methods, and computer-readable media.

### BRIEF DESCRIPTION OF THE DRAWINGS

A further understanding of the nature and advantages of the present disclosure may be realized by reference to the following drawings. In the appended figures, similar components or features may have the same reference label and designations. Further, various components of the same type may be distinguished by following the reference label by a dash and a second label that distinguishes among the similar components, or by following the reference label with a letter. If just the first reference label is used in the specification, the description is applicable to any one of the similar components having the same first reference label irrespective of the second reference label or letter.

FIG. 1 is a block diagram illustrating details of an example wireless communication network in accordance with the present disclosure.

FIG. 2 is a block diagram illustrating examples of a network node and a user equipment (UE) in accordance with the present disclosure.

FIG. 3 is a block diagram illustrating an example disaggregated base station architecture in accordance with the present disclosure.

FIG. 4 is a block diagram illustrating an example of a wireless communication system that supports a physical downlink control channel (PDCCH) blind detection procedure with a configurable number of downlink control information (DCI) sizes in accordance with the present disclosure.

FIG. 5 is a ladder diagram illustrating example wireless communications that support a PDCCH blind detection procedure with a configurable number of DCI sizes in accordance with the present disclosure.

FIG. 6 is a ladder diagram illustrating example wireless communications that support changing a number of DCI sizes permitted during a PDCCH blind detection procedure in accordance with the present disclosure.

FIG. 7 is a flow diagram illustrating an example process that supports a PDCCH blind detection procedure with a configurable number of DCI sizes in accordance with the present disclosure.

FIG. 8 is a block diagram of an example UE that supports a PDCCH blind detection procedure with a configurable number of DCI sizes in accordance with the present disclosure.

FIG. 9 is a flow diagram illustrating an example process that supports a PDCCH blind detection procedure with a configurable number of DCI sizes in accordance with the present disclosure.

FIG. 10 is a block diagram of an example network node that supports a PDCCH blind detection procedure with a configurable number of DCI sizes in accordance with the present disclosure.

### DETAILED DESCRIPTION

Various aspects of the disclosure are described more fully hereinafter with reference to the accompanying drawings. This disclosure may, however, be embodied in many different forms and is not to be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

The present disclosure provides systems, apparatus, methods, and computer-readable media for supporting a physical downlink control channel (PDCCH) blind detection procedure with a configurable number of downlink control information (DCI) sizes for wireless communication systems. Some aspects more specifically relate to enabling a user equipment (UE), during performance of a PDCCH blind detection procedure, to actively monitor a number of DCI sizes that is based on particular conditions or parameters, such as a total number of PDCCH candidates to be monitored or a PDCCH blind detection mode. For example, instead of actively monitoring the same fixed number of candidate DCI sizes during performance of PDCCH blind detection procedures, the UE may identify a DCI size limit in accordance with the total number of PDCCH candidates to be monitored or a PDCCH blind detection mode, such as a single-stage mode or a multi-stage mode, and the UE may monitor candidate DCI sizes up to the DCI size limit. As a particular, non-limiting example, if the total number of PDCCH candidates to be monitored is within a first range, the UE may identify a first DCI size limit and actively monitor a first number of candidate DCI sizes up to the first DCI size limit. Alternatively, if the total number of PDCCH candidates is within a second range that includes smaller numbers than are included the first range, the UE may identify a second DCI size limit that is larger than the first DCI size limit and actively monitor a second number of candidate DCI sizes up to the second DCI size limit, with the second number of candidate DCI sizes being greater than the first number of candidate DCI sizes. The various DCI size limit(s) may be preprogrammed at the UE and a network node, and in some implementations, the values may be specified in a wireless communications standard. Alternatively, the network node may select the DCI size limit(s) and communicate the selected DCI size limit(s) to the UE, such as via a control resource set (CORESET) configuration message or a medium access control (MAC) control element (MAC-CE). In some implementations, the DCI size limit may be dynamically configured, and a DCI size limit associated with a first time period may be different than a DCI size limit associated with a second time period. The network node may generate DCI for transmission to the UE that has a DCI size that matches one of the candidate DCI sizes monitored by the UE during the PDCCH blind detection procedure, thereby enabling detection and decoding of the DCI by the UE.

Particular implementations of the subject matter described in this disclosure can be implemented to realize one or more of the following potential advantages. In some aspects, the present disclosure provides techniques for enabling devices in a wireless network, such as a 5G NR wireless network, to monitor a configurable number of DCI sizes during performance of a PDCCH blind detection procedure, in contrast to typical PDCCH blind detection procedures in which the same fixed number of DCI sizes are monitored for one or more PDCCH candidates. In some aspects, a UE may be configured to monitor an increased number of candidate DCI sizes under certain conditions as compared to a typical PDCCH blind detection procedure. For example, if the UE is monitoring a small number of PDCCH candidates or operating in a PDCCH blind detection mode that is associated with fewer PDCCH candidates than other PDCCH blind detection mode(s), the UE may identify a larger DCI size limit and thus be able to monitor a greater number of candidate DCI sizes while still complying with a PDCCH blind detection limit. Increasing the DCI size limit, and therefore the number of candidate DCI sizes that can be monitored by the UE, may simplify DCI size alignment at the network as compared to having fewer DCI sizes. For example, increasing the number of candidate DCI sizes may reduce the likelihood that a network node artificially increases, or decreases, a size of DCI to be transmitted to the UE in order to match one of the candidate DCI sizes. Because artificially increasing or decreasing the size of DCI can reduce the available bandwidth or throughput of the wireless network and/or degrade performance of the wireless network by requiring a higher coding rate for the DCI, the techniques described herein that reduce the likelihood of artificially increasing or decreasing the DCI size can increase available bandwidth or throughput in the wireless network, and in some implementations, increase wireless communication performance between the network node and the UE.

This disclosure relates generally to providing or participating in authorized shared access between two or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, long term evolution (LTE) networks, Global System for Mobile Communications (GSM) networks, 5th Generation (5G) or new radio (NR) networks (sometimes referred to as “5G NR” networks, systems, or devices), as well as other communications networks. As described herein, the terms “networks” and “systems” may be used interchangeably.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV). 5G NR networks contemplate diverse deployments, diverse spectrum, and diverse services and devices that may be implemented using an OFDM-based unified, air interface.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust mm Wave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 gigahertz (GHz) FDD or TDD implementations, subcarrier spacing may occur with 15 kilohertz (kHz), for example over 1, 5, 10, 20 megahertz (MHz), and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases. For clarity, certain aspects of the present disclosure may be described below with reference to example 5G NR implementations or in a 5G-centric way, and 5G terminology may be used as illustrative examples in portions of the description below; however, the description is not intended to be limited to 5G applications.

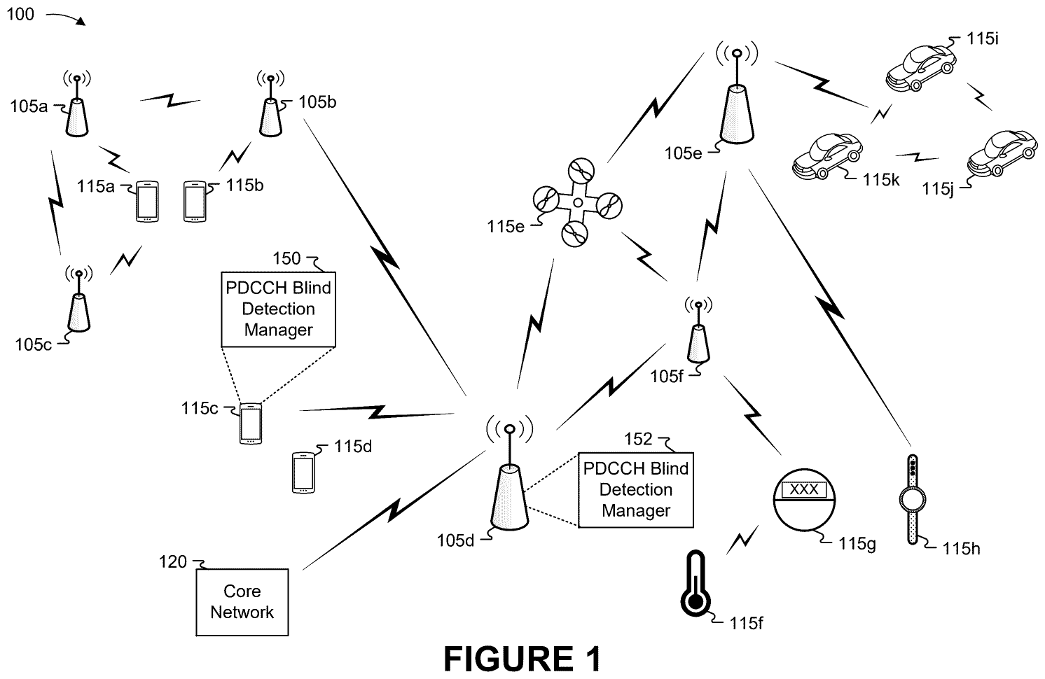

FIG. 1 is a block diagram illustrating details of an example wireless communication network 100 in accordance with the present disclosure. The wireless communication network 100 may, for example, be or include elements of a 5G (or NR) network or a 6G network, among other examples. As appreciated by those skilled in the art, components appearing in FIG. 1 are likely to have related counterparts in other network arrangements including, for example, cellular-style network arrangements and non-cellular-style-network arrangements, such as device-to-device, peer-to-peer, or ad hoc network arrangements, among other examples.

The wireless communication network 100 illustrated in FIG. 1 includes multiple network nodes 105, also referred to as network entities, and multiple user equipments (UEs) 115. A network node may be a station that communicates with UEs and may be referred to as a base station, an evolved node B (eNB), a next generation eNB (gNB), an access point, and the like. Each network node 105 may provide communication coverage for a particular geographic area. In 3GPP, the term “cell” can refer to this particular geographic coverage area of a network node or a network node subsystem serving the coverage area, depending on the context in which the term is used. In implementations of the wireless communication network 100 herein, the network nodes 105 may be associated with a same operator or different operators, such as the wireless communication network 100 may include a plurality of operator wireless networks. In some examples, an individual network node 105 or UE 115 may be operated by more than one network operating entity. In some other examples, each network node 105 and UE 115 may be operated by a single network operating entity.

The network nodes 105 and the UEs 115 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHZ), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, in accordance with user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 105 may include one or more devices, components, or systems that enable communication between a UE 115 and one or more devices, components, or systems of the wireless communication network 100. A network node 105 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 105 may be a device or system that implements part of a radio protocol stack, a device or system that implements a full radio protocol stack (such as a full gNB protocol stack), or a collection of devices or systems that collectively implement the full radio protocol stack. For example, and as shown, a network node 105 may be an aggregated network node (having an aggregated architecture), meaning that the network node 105 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 115 and a core network 120 of the wireless communication network 100.

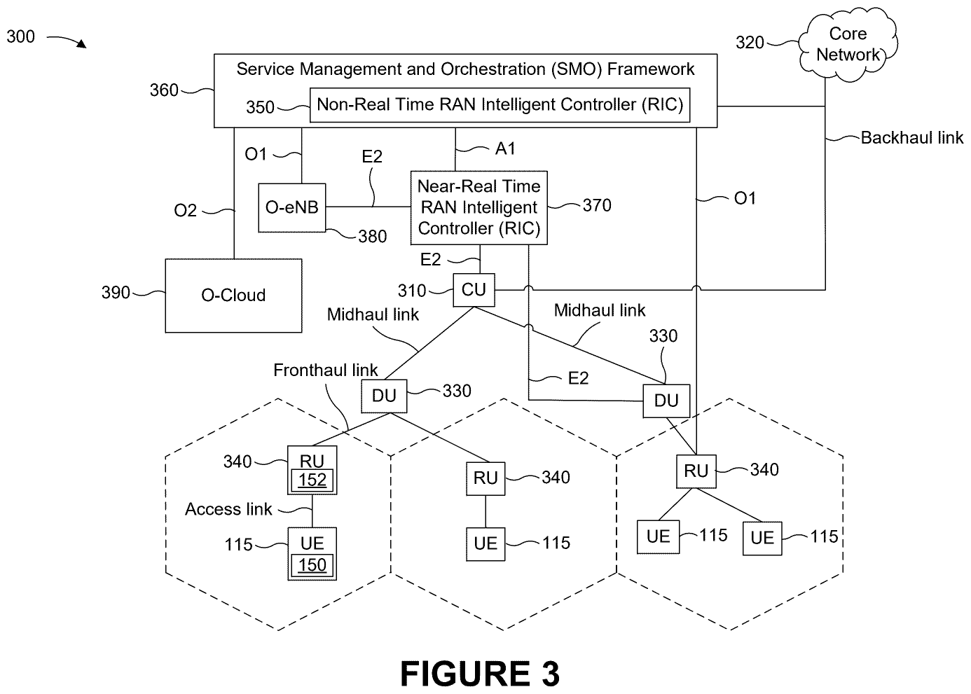

Alternatively, a network node 105 may be a disaggregated network node (sometimes referred to as a disaggregated base station), meaning that the network node 105 may implement a radio protocol stack that is physically distributed and/or logically distributed among two or more nodes in the same geographic location or in different geographic locations. For example, a disaggregated network node may have a disaggregated architecture, as further described herein with reference to FIG. 3. In some deployments, disaggregated network nodes 105 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 105 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 115, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 115.

In some aspects, a single network node 105 may include a combination of one or more CUs, one or more DUs, and/or one or more RUs. Additionally, or alternatively, a network node 105 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 105 (for example, a base station, an RU, or a TRP) may provide communication coverage for a particular geographic area. In the 3GPP, the term “cell” can refer to a coverage area of a network node 105 or to a network node 105 itself, depending on the context in which the term is used. A network node 105 may support one or multiple (for example, three) cells. In some examples, a network node 105 may provide communication coverage for a macro cell, a pico cell, a femto cell, or another type of cell. A macro cell may cover a relatively large geographic area (for example, several kilometers in radius) and may allow unrestricted access by UEs 115 with service subscriptions. A pico cell may cover a relatively small geographic area and may allow unrestricted access by UEs 115 with service subscriptions. A femto cell may cover a relatively small geographic area (for example, a home) and may allow restricted access by UEs 115 having association with the femto cell (for example, UEs 115 in a closed subscriber group (CSG)). A network node 105 for a macro cell may be referred to as a macro network node. A network node 105 for a pico cell may be referred to as a pico network node. A network node 105 for a femto cell may be referred to as a femto network node or an in-home network node. In some examples, a cell may not necessarily be stationary. For example, the geographic area of the cell may move according to the location of an associated mobile network node 105 (for example, a train, a satellite base station, an unmanned aerial vehicle, or an NTN network node).

The wireless communication network 100 may be a heterogeneous network that includes network nodes 105 of different types, such as macro network nodes, pico network nodes, femto network nodes, relay network nodes, aggregated network nodes, and/or disaggregated network nodes, among other examples. In the example shown in FIG. 1, network nodes 105d and 105e are regular macro network nodes, while network nodes 105a-105c are macro network nodes enabled with one of 3 dimension (3D), full dimension (FD), or massive MIMO. Network nodes 105a-105c take advantage of their higher dimension MIMO capabilities to exploit 3D beamforming in both elevation and azimuth beamforming to increase coverage and capacity. Network node 105f is a small cell network node which may be a home node or portable access point. A network node may support one or multiple cells, such as two cells, three cells, four cells, and the like. Various different types of network nodes 105 may generally transmit at different power levels, serve different coverage areas, and/or have different impacts on interference in the wireless communication network 100 than other types of network nodes 105. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 105 may be, may include, or may operate as an RU, a TRP, or a base station that communicates with one or more UEs 115 via a radio access link (which may be referred to as a “Uu” link). The radio access link may include a downlink and an uplink. “Downlink” (or “DL”) refers to a communication direction from a network node 105 to a UE 115, and “uplink” (or “UL”) refers to a communication direction from a UE 115 to a network node 105. Downlink channels may include one or more control channels and one or more data channels. A downlink control channel may be used to transmit DCI (for example, scheduling information, reference signals, and/or configuration information) from a network node 105 to a UE 115. A downlink data channel may be used to transmit downlink data (for example, user data associated with a UE 115) from a network node 105 to a UE 115. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 115 to a network node 105. An uplink data channel may be used to transmit uplink data (for example, user data associated with a UE 115) from a UE 115 to a network node 105. Uplink control channels may include one or more physical uplink control channels (PUCCHs), and uplink data channels may include one or more physical uplink shared channels (PUSCHs). The downlink and the uplink may each include a set of resources on which the network node 105 and the UE 115 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 115. A UE 115 may be configured with both an uplink BWP and a downlink BWP (where the uplink BWP and the downlink BWP may be the same BWP or different BWPs). A BWP may be dynamically configured (for example, by a network node 105 transmitting a DCI configuration to the one or more UEs 115) and/or reconfigured, which means that a BWP can be adjusted in real-time (or near-real-time) in accordance with changing network conditions in the wireless communication network 100 and/or in accordance with the specific requirements of the one or more UEs 115. This enables more efficient use of the available frequency domain resources in the wireless communication network 100 because fewer frequency domain resources may be allocated to a BWP for a UE 115 (which may reduce the quantity of frequency domain resources that a UE 115 is required to monitor), leaving more frequency domain resources to be spread across multiple UEs 115. Thus, BWPs may also assist in the implementation of lower-capability UEs 115 by facilitating the configuration of smaller bandwidths for communication by such UEs 115.

As described above, in some aspects, the wireless communication network 100 may be, may include, or may be included in, an IAB network. In an IAB network, at least one network node 105 is an anchor network node that communicates with the core network 120. An anchor network node 105 may also be referred to as an IAB donor (or “IAB-donor”). The anchor network node 105 may connect to the core network 120 via a wired backhaul link. For example, an Ng interface of the anchor network node 105 may terminate at the core network 120. Additionally, or alternatively, an anchor network node 105 may connect to one or more devices of the core network 120 that provide a core access and mobility management function (AMF). An IAB network also generally includes multiple non-anchor network nodes 105, which may also be referred to as relay network nodes or simply as IAB nodes (or “IAB-nodes”). Each non-anchor network node 105 may communicate directly with the anchor network node 105 via a wireless backhaul link to access the core network 120, or may communicate indirectly with the anchor network node 105 via one or more other non-anchor network nodes 105 and associated wireless backhaul links that form a backhaul path to the core network 120. Some anchor network nodes 105 or other non-anchor network nodes 105 may also communicate directly with one or more UEs 115 via wireless access links that carry access traffic. In some examples, network resources for wireless communication (such as time resources, frequency resources, and/or spatial resources) may be shared between access links and backhaul links.

The wireless communication network 100 may support synchronous or asynchronous operation. For synchronous operation, the network nodes may have similar frame timing, and transmissions from different network nodes may be approximately aligned in time. For asynchronous operation, the network nodes may have different frame timing, and transmissions from different network nodes may not be aligned in time. In some scenarios, networks may be enabled or configured to handle dynamic switching between synchronous or asynchronous operations.

The UEs 115 are physically dispersed throughout the wireless communication network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile phone, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A UE 115 may additionally be an “Internet of Things” (IoT) or “Internet of Everything” (IoE) device, an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples. The UEs 115 may also include digital home or smart home devices, such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless communication network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access the wireless communication network 100.

A mobile apparatus, such as the UEs 115, may be able to communicate with any type of the network nodes, whether macro network nodes, pico network nodes, femto network nodes, macro base stations, pico base stations, femto base stations, relays, and the like. In FIG. 1, a communication link (represented as a lightning bolt) indicates wireless transmissions between a UE and a serving network node, which is a network node designated to serve the UE on the downlink or uplink, wireless transmissions between network nodes, and backhaul transmissions between network nodes. Backhaul communication between network nodes of the wireless communication network 100 may occur using wired or wireless communication links.

In some examples, two or more UEs 115 (for example, shown as UE 115i and UE 115j) may communicate directly with one another using sidelink communications (for example, without communicating by way of a network node 105 as an intermediary). As an example, the UE 115i may directly transmit data, control information, or other signaling as a sidelink communication to the UE 115j. This is in contrast to, for example, the UE 115i first transmitting data in a UL communication to a network node 105, which then transmits the data to the UE 115j in a DL communication. In various examples, the UEs 115 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 105 may schedule and/or allocate resources for sidelink communications between UEs 115 in the wireless communication network 100. In some other deployments and configurations, a UE 115 (instead of a network node 105) may perform, or collaborate or negotiate with one or more other UEs to perform, scheduling operations, resource selection operations, and/or other operations for sidelink communications.

In some examples, the UEs 115 and the network nodes 105 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

As an example of operation at the wireless communication network 100, the network nodes 105a-105c serve the UEs 115a and 115b using 3D beamforming and coordinated spatial techniques, such as coordinated multipoint (COMP) or multi-connectivity. Macro network node 105d performs backhaul communications with the network nodes 105a-105c, as well as with the small cell network node 105f. Macro network node 105d also transmits multicast services which are subscribed to and received by the UEs 115c and 115d. Such multicast services may include mobile television or streaming video, or may include other services for providing community information, such as weather emergencies or alerts, such as Amber alerts or gray alerts.

The wireless communication network 100 of implementations supports mission critical communications with ultra-reliable and redundant links for mission critical devices, such the UE 115e, which is a drone. Redundant communication links with the UE 115e include communication links from the macro network nodes 105d and 105e, as well as the small cell network node 105f. Other machine type devices, such as UE 115f (thermometer), the UE 115g (smart meter), and the UE 115h (wearable device) may communicate through the wireless communication network 100 either directly with network nodes, such as the small cell network node 105f and the macro network node 105e, or in multi-hop configurations by communicating with another user device which relays its information to the network, such as the UE 115f communicating temperature measurement information to the UE 115g, which is then reported to the network through the small cell network node 105f. The wireless communication network 100 may provide additional network efficiency through dynamic, low-latency TDD or FDD communications, such as in a vehicle-to-vehicle (V2V) mesh network between the UEs 115i-115k communicating with the macro network node 105e.

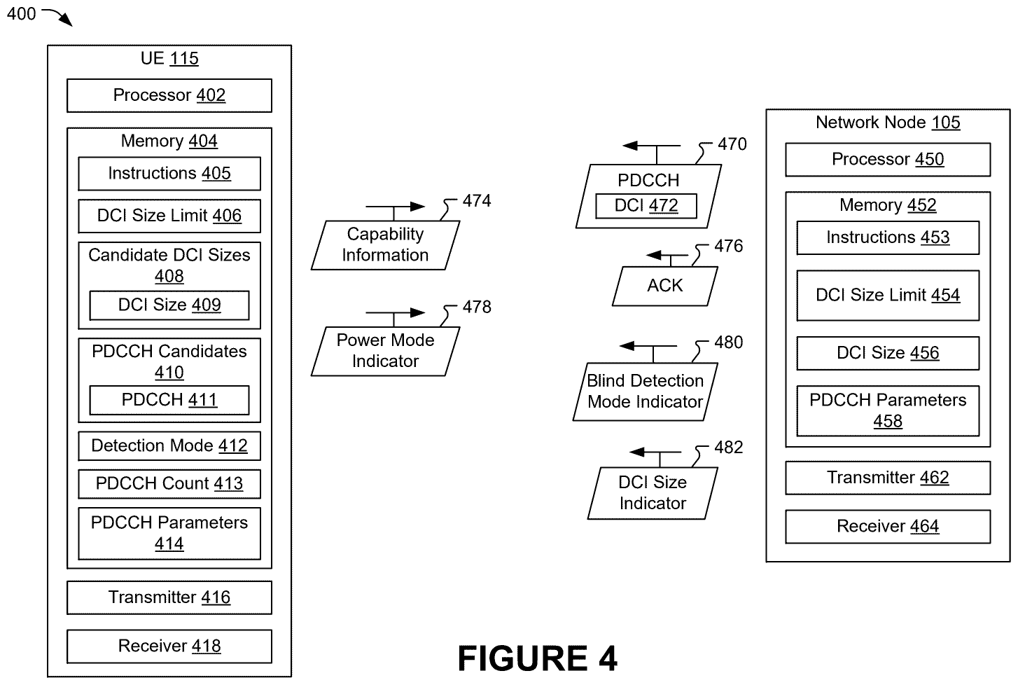

In some aspects, one or more of the network nodes 105 and one or more of the UEs may perform wireless communications that support a PDCCH blind detection procedure with a configurable number of DCI sizes. For example, one or more of the UEs 115 (such as the UE 115c) may include a PDCCH blind detection manager 150 that manages operations that support a PDCCH blind detection procedure with a configurable number of DCI sizes. The operations may include identifying a DCI size limit associated with a total number of PDCCH candidates or a PDCCH blind detection mode, performing blind detection operations on PDCCH candidates for various candidate DCI sizes within the identified DCI size limit, receiving DCI having the identified DCI size, or a combination thereof, as further described herein with reference to FIG. 4. As another example, one or more of the network nodes 105 (such as the network node 105d) may include a PDCCH blind detection manager 152 that manages operations that support a PDCCH blind detection procedure with a configurable number of DCI sizes. The operations may include selecting a DCI size from a set of candidate DCI sizes, transmitting DCI having the identified DCI size, or a combination thereof, as further described herein with reference to FIG. 4.

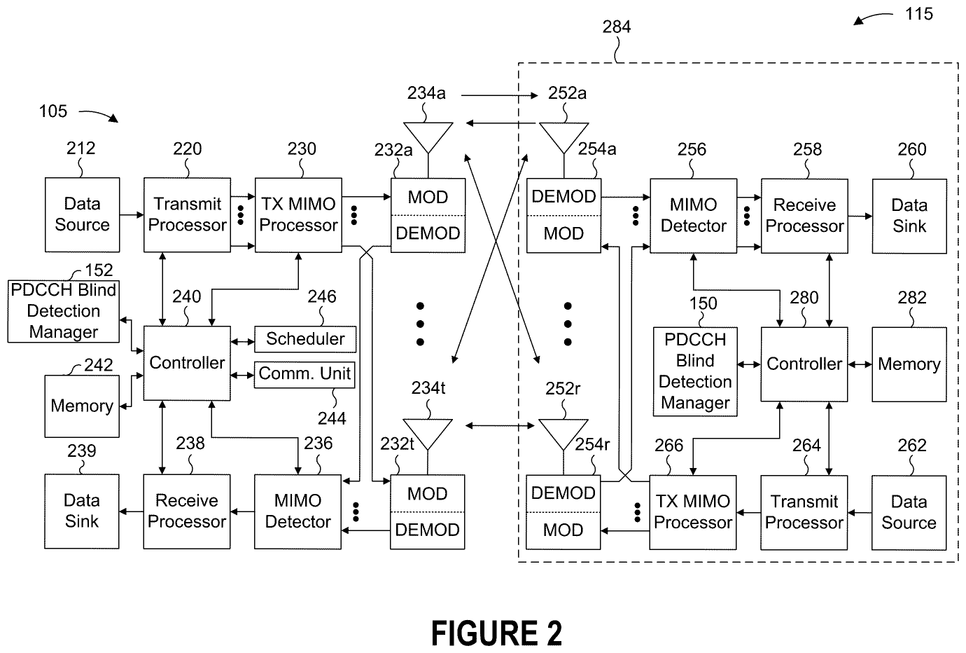

FIG. 2 is a block diagram illustrating examples of a network node 105 and a UE 115 in accordance with the present disclosure. The network node 105 and the UE 115 may be one of the network nodes 105 and one of the UEs 115 in FIG. 1. For a restricted association scenario, the network node 105 may be the small cell network node 105f in FIG. 1, and the UE 115 may be the UE 115c or 115d operating in a service area of the network node 105f, which in order to access the small cell network node 105f, would be included in a list of accessible UEs for the small cell network node 105f. Additionally, the network node 105 may be a base station or network entity of some other type. As shown in FIG. 2, the network node 105 may be equipped with antennas 234a through 234t, and the UE 115 may be equipped with antennas 252a through 252r for facilitating wireless communications.

For downlink communication from the network node 105 to the UE 115, a transmit processor 220 may receive data (“downlink data”) from a data source 212 (such as a data pipeline or a data queue) and control information from a controller 240. The control information may be for the physical broadcast channel (PBCH), physical control format indicator channel (PCFICH), physical hybrid-ARQ (automatic repeat request) indicator channel (PHICH), PDCCH, enhanced physical downlink control channel (EPDCCH), or MTC physical downlink control channel (MPDCCH), among other examples. The data may be for the PDSCH, among other examples. The transmit processor 220 may process, such as encode and symbol map, such as in accordance with a selected modulation and coding scheme (MCS), the data and control information to obtain data symbols and control symbols, respectively. Additionally, the transmit processor 220 may generate reference symbols for reference signals, such as for a cell-specific reference signal (CRS), a demodulation reference signal (DMRS), or a channel state information (CSI) reference signal (CSI-RS) and/or synchronization signals, such as for a primary synchronization signal (PSS) or a secondary synchronization signal (SSS).

Transmit (TX) multiple-input multiple-output (MIMO) processor 230 may perform spatial processing on the data symbols, the control symbols, and/or the reference symbols, if applicable, and may provide output symbol streams to modems 232a through 232t. For example, each output symbol stream may be provided to a respective modulator component (shown as MOD) of a modem 232. In some examples, spatial processing performed on the data symbols, the control symbols, and/or the reference symbols may include precoding. Each modem 232 may use the respective modulator component to process a respective output symbol stream, such as for OFDM, among other examples, to obtain an output sample stream. Each modem 232 may additionally or alternatively use the respective modulator component to process the output sample stream to obtain a downlink signal. For example, to process the output sample stream, each modem 232 may use the respective modulator component to convert to analog, amplify, filter, and upconvert the output sample stream to obtain the downlink signal. The modems 232a through 232t may together transmit a set of downlink signals from via the antennas 234a through 234t, respectively.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

At the UE 115, the antennas 252a through 252r may receive the downlink signals from the network node 105 and may provide a set of received signals to modems 254a through 254r. For example, each received signal may be provided to a respective demodulator component (shown as DEMOD) of a modem 254. Each modem 254 may use the respective demodulator component to condition a respective received signal to obtain input samples. For example, to condition the respective received signal, the demodulator component of each modem 254 may filter, amplify, downconvert, and/or digitize the respective received signal to obtain the input samples. Each modem 254 may use the respective demodulator component to further process the input samples, such as for OFDM, among other examples, to obtain received symbols. MIMO detector 256 may obtain received symbols from modems 254a through 254r, perform MIMO detection on the received symbols if applicable, and provide detected symbols. Receive processor 258 may process the detected symbols, provide decoded data for the UE 115 to a data sink 260 (which may include a data pipeline, a data queue, and/or an application executed on the UE 115), and provide decoded control information to a controller 280. For example, to process the detected symbols, the receive processor 258 may demodulate, deinterleave, and decode the detected symbols.

In some aspects, one or a combination of the antenna(s) 252, the modem(s) 254, the MIMO detector 256, the receive processor 258, the transmit processor 264, or the TX MIMO processor 266 may be included in a transceiver that is included in the UE 115. The transceiver may be under control of and used by one or more processors, such as the controller 280, and in some aspects in conjunction with processor-readable code stored in the memory 282, to perform aspects of the methods, processes, or operations described herein. In some aspects, the UE 115 may include another interface, another communication component, and/or another component that facilitates communication with the network node 105 and/or another UE 115. Additionally, or alternatively, one or more of the components of the UE 115 may be included in a housing 284.

For uplink communications from the UE 115 to the network node 105, a transmit processor 264 may receive and process data (“uplink data”) from a data source 262 and control information (such as for the PUCCH) from the controller 280. The control information may include one or more parameters, feedback, one or more signal measurements, and/or other types of control information. In some aspects, the receive processor 258 and/or the controller 280 may determine, for a received signal (such as received from the network node 105 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 115 by the network node 105.

The transmit processor 264 may generate reference symbols for a reference signal, such as an uplink DMRS, an uplink sounding reference signal (SRS), and/or another type of reference signal. The symbols from the transmit processor 264 may be precoded by a TX MIMO processor 266, if applicable, and further processed by the modems 254a through 254r (such as for DFT-s-OFDM or CP-OFDM, among other examples). The TX MIMO processor 266 may perform spatial processing (for example, precoding) on the data symbols, the control symbols, and/or the reference symbols, if applicable, and may provide a set of output symbol streams to the modems 254. For example, each output symbol stream may be provided to a respective modulator component (shown as MOD) of a modem 254. Each modem 254 may use the respective modulator component to process a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254r may transmit a set of uplink signals via the corresponding antennas 252a through 252r, respectively. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 115) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

At network node 105, the uplink signals from the UE 115 may be received by antennas 234a through 234t, processed by demodulator components of the modems 232a through 232t, detected by a MIMO detector 236 if applicable, and further processed by a receive processor 238 to obtain decoded data and/or control information sent by the UE 115. The receive processor 238 may provide the decoded data to a data sink 239 (which may be a data pipeline, a data queue, and/or another type of data sink) and provide the decoded control information to the controller 240.

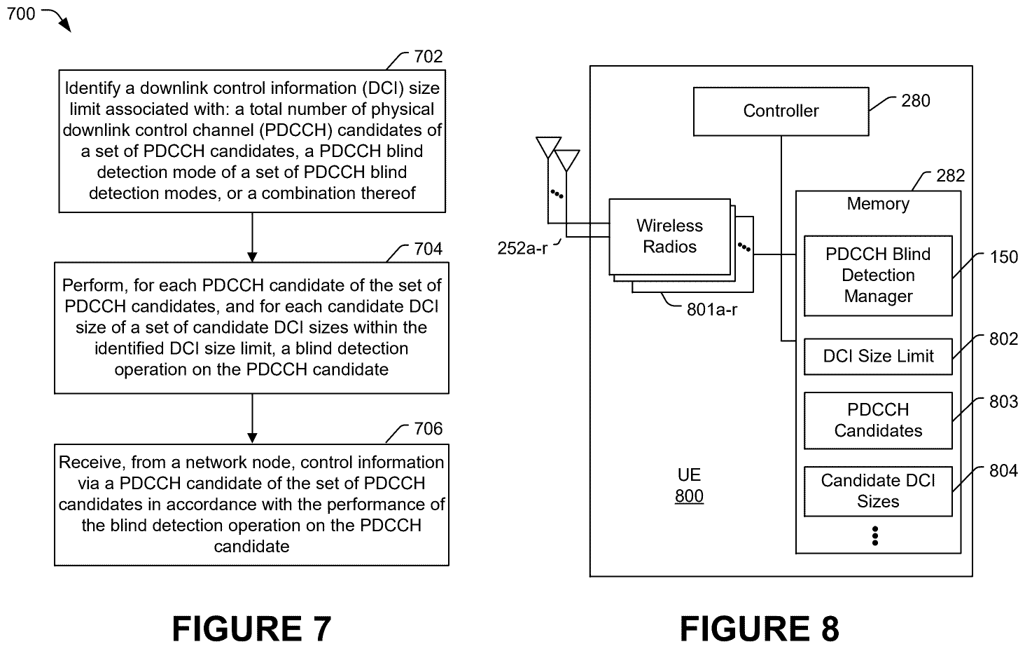

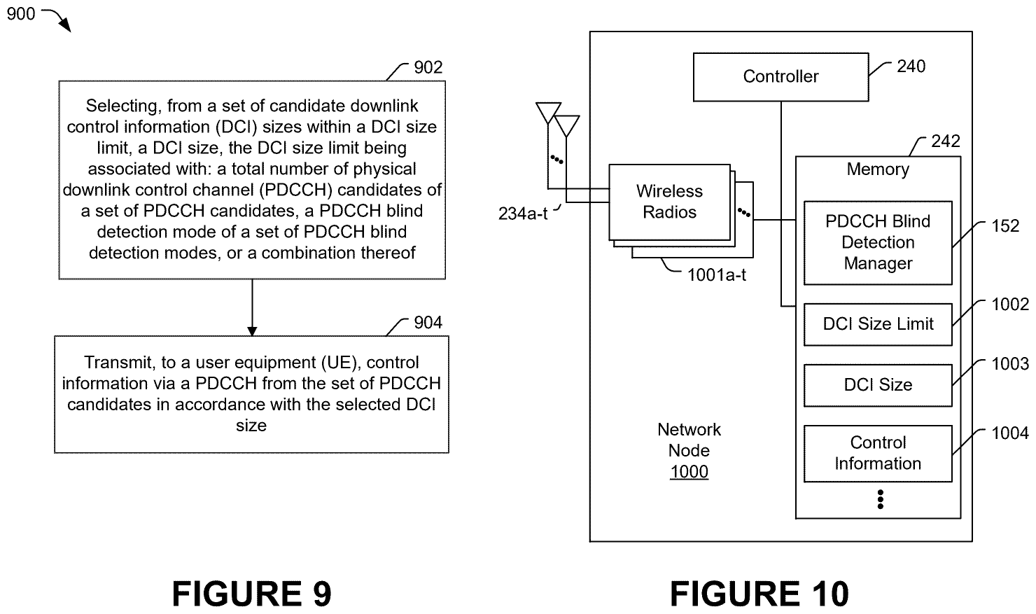

The controllers 240 and 280 may direct the operation at the network node 105 and the UE 115, respectively. The controller 240 (or other processors and modules at the network node 105) may perform or direct the execution of various processes for the techniques described herein, such as to perform or direct the execution illustrated in FIG. 9, or other processes for the techniques described herein. Similarly, the controller 280 (or other processors and modules at the UE 115) may perform or direct the execution of various processes for the techniques described herein, such as to perform or direct the execution illustrated in FIG. 7, or other processes for the techniques described herein. For example, the controller 240 and/or the controller 280 may perform or control operations that support a PDCCH blind detection procedure with a configurable number of DCI sizes. Additionally, or alternatively, the UE 115 may include the PDCCH blind detection manager 150 and the network node 105 may include the PDCCH blind detection manager 152 that are configured to manage operations to support a PDCCH blind detection procedure with a configurable number of DCI sizes, as further described herein. Although referred to as “controllers”, the controllers 240 and 280 may include one or more processors and/or one or more controllers, and also or in the alternative be referred to as “processors” or “controller/processors”. In some aspects, a single processor may perform all of the operations described as being performed by the one or more processors or the one or more controllers. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors.

The memories 242 and 282 may store data and program codes for the network node 105 and the UE 115, respectively. Reference to “one or more memories” should be understood to refer to any one or more memories of a corresponding device, such as the memory described in connection with FIG. 2. For example, an operation described as being performed by one or more memories can be performed by the same subset of the one or more memories or different subsets of the one or more memories.

The network node 105 may use a scheduler 246 to schedule one or more UEs 115 for downlink or uplink communications. In some aspects, the scheduler 246 may use DCI to dynamically schedule DL transmissions to the UE 115 and/or UL transmissions from the UE 115. In some examples, the scheduler 246 may allocate recurring time domain resources and/or frequency domain resources that the UE 115 may use to transmit and/or receive communications using an RRC configuration (for example, a semi-static configuration), for example, to perform semi-persistent scheduling (SPS) or to configure a configured grant (CG) for the UE 115.

In some examples, the network node 105 may use a communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 105 may use the communication unit 244 to transmit and/or receive data associated with the UE 115 or to perform network control signaling, among other examples. The communication unit 244 may include a transceiver and/or an interface, such as a network interface.

One or more antennas of the antennas 252 or the antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 115 or network nodes 105 may include different numbers of antenna elements. For example, a UE 115 may include a single antenna element, two antenna elements, four antenna elements, eight antenna elements, or a different number of antenna elements. As another example, a network node 105 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

FIG. 3 is a block diagram illustrating an example disaggregated base station architecture 300 in accordance with the present disclosure. One or more components of the example disaggregated base station architecture 300 may be, may include, or may be included in one or more network nodes (such as one or more network nodes 105). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). In some implementations, the core network 320 includes or corresponds to the core network 120 of FIG. 1. The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 115 via respective RF access links. In some deployments, a UE 115 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

The UEs 115, the CU 310, the DUs 330, the RUs 340, or any other component(s) of FIG. 3 may implement one or more techniques or perform one or more operations associated with PDCCH blind detection with a configurable number of DCI sizes, as described further herein. For example, the UEs 115 may include the PDCCH blind detection manager 150 and the RUs 340 may include the PDCCH blind detection manager 152, which may manage operations to support PDCCH blind detection with a configurable number of DCI sizes. Although shown as being included in a single UE 115 in FIG. 3, any of the UEs 115 may include the PDCCH blind detection manager 150, and although shown as being included in a single RU 340 in FIG. 3, any of the RUs 340, the DUs 330, the CU 310, the Non-RT RIC 350, the SMO Framework 360, the Near-RT RIC 370, or a combination thereof, may include the PDCCH blind detection manager 152. The PDCCH blind detection manager 150 may direct operations of, for example, the process 700 of FIG. 7, or other processes as described herein (alone or in conjunction with one or more other processors). Similarly, the PDCCH blind detection manager 152 may direct operations of, for example, the process 900 of FIG. 9, or other processes as described herein (alone or in conjunction with one or more other processors).

In some examples, the PDCCH blind detection manager 150 or the PDCCH blind detection manager 152 may include, or have access to, a non-transitory computer-readable medium storing a set of instructions (for example, code or program code) for wireless communication. The memory may include one or more memories, such as a single memory or multiple different memories (of the same type or of different types). For example, the set of instructions, when executed (for example, directly, or after compiling, converting, or interpreting) by the PDCCH blind detection manager 150 or one or more processors of the UE 115 may cause the one or more processors or the PDCCH blind detection manager 150 to perform the process 700 of FIG. 7 or other processes as described herein. As another example, the set of instructions, when executed (for example, directly, or after compiling, converting, or interpreting) by the PDCCH blind detection manager 152, one or more processors of the network node 105, the CU 310, the DU 330, the RU 340, the Non-RT RIC 350, the SMO Framework 360, or the Near-RT RIC 370, may cause the one or more processors or the PDCCH blind detection manager 152 to perform the process 900 of FIG. 9 or other processes as described herein. In some examples, executing instructions may include running the instructions, converting the instructions, compiling the instructions, and/or interpreting the instructions, among other examples.

FIG. 4 is a block diagram illustrating an example wireless communication system 400 that supports a PDCCH blind detection procedure with a configurable number of DCI sizes in accordance with the present disclosure. As used herein, PDCCH blind detection may also be referred to as PDCCH blind decoding, and both refer to a procedure by which a wireless device monitors PDCCH candidates to determine whether at least one of the PDCCH candidates include DCI sent to the wireless device. In some examples, the wireless communication system 400 may implement aspects of the wireless communication network 100. The wireless communication system 400 includes the UE 115 and the network node 105. Although one UE 115 and one network node 105 are illustrated, in some other implementations, the wireless communication system 400 may generally include multiple UEs 115, multiple network nodes 105, or both.

The UE 115 can include a variety of components (such as structural, hardware components) used for carrying out one or more functions described herein. For example, these components can include one or more processors 402 (hereinafter referred to collectively as “the processor 402”), one or more memory devices 404 (hereinafter referred to collectively as “the memory 404”), one or more transmitters 416 (hereinafter referred to collectively as “the transmitter 416”), and one or more receivers 418 (hereinafter referred to collectively as “the receiver 418”). Although referred to as a processor, the UE 115 may include one or more chips, system-on-chips (SoCs), chipsets, packages, or devices that individually or collectively constitute or include a processing system. The processing system includes processor (or “processing”) circuitry in the form of one or multiple processors (such as the processor 402), microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor 402” or “the processor circuitry”).

One or more of the processors 402 may be individually or collectively configurable or configured to perform various functions or operations described herein. A group of processors collectively configurable or configured to perform a set of functions may include a first processor configurable or configured to perform a first function of the set of functions and a second processor configurable or configured to perform a second function of the set of functions, or may include the group of processors all being configured or configurable to perform the set of functions. The processor 402 may be configured to execute instructions 405 stored in the memory 404 to perform the operations described herein. In some implementations, the processor 402 includes or corresponds to the receive processor 258, the transmit processor 264, the controller 280, or a combination thereof, and the memory 404 includes or corresponds to the memory 282, described with reference to FIG. 2. In some implementations, the processor 402, the memory 404, the instructions 405, another component of the UE 115, or a combination thereof, may include or correspond to the PDCCH blind detection manager 150 of FIGS. 1-3 and/or may perform the operations associated with the PDCCH blind detection manager 150 to support a PDCCH blind detection procedure with a configurable number of DCI sizes.

The memory 404 may be configured to store the instructions 405, a DCI size limit 406, one or more candidate DCI sizes (hereinafter referred to collectively as “the candidate DCI sizes 408”), one or more PDCCH candidates (hereinafter referred to collectively as “the PDCCH candidates 410”), a PDCCH blind detection mode indicator (hereinafter referred to as “the detection mode indicator 412”), a PDCCH count 413, and one or more PDCCH parameters (hereinafter referred to collectively as “the PDCCH parameters 414”). The DCI size limit 406 represents a maximum number of different DCI sizes that can be monitored by the UE 115 during PDCCH blind detection operations performed on a PDCCH candidate. The candidate DCI sizes 408 represent one or more possible DCI sizes for monitoring by the UE 115 during performance of PDCCH blind detection operation on a PDCCH candidate. The candidate DCI sizes 408 may include a DCI size 409 that is identified by the UE 115 during performance of a PDCCH blind detection procedure, as further described herein. In some implementations, a quantity of the candidate DCI sizes 408 is less than or equal to the DCI size limit 406.

The PDCCH candidates 410 represent one or more candidate PDCCHs via which the network node 105 may transmit control information and for which the UE 115 may perform a PDCCH blind detection procedure, as further described herein. The PDCCH candidates 410 may include a PDCCH 411 that is identified by the UE 115 during performance of a PDCCH blind detection procedure, as further described herein. In some implementations, the PDCCH candidates 410 include multiple sets of PDCCH candidates. The detection mode indicator 412 indicates a PDCCH blind detection mode that the UE 115 is operating in accordance with, such as during performance of a PDCCH blind detection procedure. In aspects, the detection mode indicator 412 indicates a type of PDCCH blind detection procedure being performed by the UE 115, such as a single-stage procedure or a multi-stage procedure. In some implementations, the detection mode indicator 412 has a first value if the UE 115 is performing a multi-stage PDCCH blind detection procedure, and the detection mode indicator 412 has a second value if the UE 115 is performing a single-stage PDCCH blind detection procedure.

The PDCCH count 413 represents a total number of PDCCH candidates that are expected to be decoded/detected by the UE 115 by performance of blind detection operations on the PDCCH candidates as part of a PDCCH blind detection procedure. The PDCCH count 413 may represent a quantity of PDCCH candidates included in the PDCCH candidates 410, if the UE 115 expects to perform PDCCH blind detection operations on the PDCCH candidates 410. For a single-stage PDCCH blind detection procedure, the PDCCH count 413 is a count of the PDCCH candidates included in a single set of PDCCH candidates associated with the procedure. For example, if the single-stage PDCCH blind detection procedure is to be performed on eight PDCCH candidates, the PDCCH count 413 may have a value of eight. For a multi-stage PDCCH blind detection procedure, the PDCCH count 413 is a count of PDCCH candidates are included in a second or filtered set of PDCCH candidates after one or more prior stages that may filter the PDCCH candidates or otherwise reduce the number of PDCCH candidates from an initial set. As part of the multi-stage PDCCH blind detection procedure, the UE 115 is expected to perform blind detection operations on this second or filtered set of PDCCH candidates. For example, if the multi-stage PDCCH blind detection procedure is associated with an initial set of eight PDCCH candidates that is reduced to a filtered set of four PDCCH candidates during at least one stage, and the UE 115 is expected to perform blind detection operations on the filtered set of four PDCCH candidates during a later stage, the PDCCH count 413 may have a value of four.

The PDCCH parameters 414 include or indicate one or more parameters associated with the PDCCH candidates 410, a PDCCH blind detection procedure to be performed by the UE 115, or a combination thereof. For example, the PDCCH parameters 414 may include or indicate a subcarrier spacing associated with the PDCCH candidates 410, a frequency range associated with the PDCCH candidates 410, a frequency band associated with the PDCCH candidates 410, a total number of actively monitored components associated with the PDCCH candidates 410, other parameters, or a combination thereof. Additionally, or alternatively, the PDCCH parameters 414 may include or indicate a PDCCH blind detection limit, a non-overlapping control channel element (CCE) limit, a PDCCH monitoring limit, other parameters, limits, or thresholds, or a combination thereof.

The transmitter 416 is configured to transmit reference signals, control information and data to one or more other devices, and the receiver 418 is configured to receive reference signals, synchronization signals, control information and data from one or more other devices. For example, the transmitter 416 may transmit signaling, control information and data to, and the receiver 418 may receive signaling, control information and data from, the network node 105. In some implementations, the transmitter 416 and the receiver 418 may be integrated in one or more transceivers. Additionally, or alternatively, the transmitter 416 or the receiver 418 may include or correspond to one or more components of the UE 115 described with reference to FIG. 2.

The network node 105 can include a variety of components (such as structural, hardware components) used for carrying out one or more functions described herein. For example, these components can include one or more processors 450 (hereinafter referred to collectively as “the processor 450”), one or more memory devices 452 (hereinafter referred to collectively as “the memory 452”), one or more transmitters 462 (hereinafter referred to collectively as “the transmitter 462”), and one or more receivers 464 (hereinafter referred to collectively as “the receiver 464”). Although referred to as a processor, the network node 105 may include one or more chips, SoCs, chipsets, packages, or devices that individually or collectively constitute or include a processing system. The processing system includes processor (or “processing”) circuitry in the form of one or multiple processors (such as the processor 450), microprocessors, processing units (such as CPUs, GPUs, NPUs and/or DSPs), processing blocks, ASICs, PLDs (such as FPGAs), or other discrete gate or transistor logic or circuitry (all of which may be generally referred to herein individually as “processors” or collectively as “the processor 450” or “the processor circuitry”).

One or more of the processors 450 may be individually or collectively configurable or configured to perform various functions or operations described herein. A group of processors collectively configurable or configured to perform a set of functions may include a first processor configurable or configured to perform a first function of the set of functions and a second processor configurable or configured to perform a second function of the set of functions, or may include the group of processors all being configured or configurable to perform the set of functions. The processor 450 may be configured to execute instructions 453 stored in the memory 452 to perform the operations described herein. In some implementations, the processor 450 includes or corresponds to the receive processor 238, the transmit processor 220, the controller 240, or a combination thereof, and the memory 452 includes or corresponds to the memory 242, described with reference to FIG. 2. In some implementations, the processor 450, the memory 452, the instructions 453, another component of the network node 105, or a combination thereof, may include or correspond to the PDCCH blind detection manager 152 of FIGS. 1-3 and/or may perform the operations associated with the PDCCH blind detection manager 152 to support PDCCH blind detection with a configurable number of DCI sizes.

The memory 452 may be configured to store the instructions 453, a DCI size limit 454, a DCI size 456, and one or more PDCCH parameters (hereinafter referred to collectively as “the PDCCH parameters 458”). The DCI size limit 454 represents a maximum number of different DCI sizes that are to be attempted by the UE 115 during PDCCH blind detection operations performed on a PDCCH candidate. In some examples, the DCI size limit 454 stored at the network node 105 is the same as the DCI size limit 406 stored at the UE 115. The DCI size 456 represents a selected DCI size for DCI to be sent to the UE 115. In some examples, the DCI size 456 stored at the network node 105 is the same as one of the candidate DCI sizes 408 stored at the UE 115. The PDCCH parameters 458 include or indicate a PDCCH blind detection procedure to be performed by the UE 115, one or more aspects of PDCCH candidates associated with the PDCCH blind detection procedure, or a combination thereof. For example, the PDCCH parameters 458 may include or indicate subcarrier spacing(s), frequency range(s), frequency band(s), total number(s) of actively monitored components, a PDCCH blind detection limit, a non-overlapping CCE limit, a PDCCH monitoring limit, other parameters, limits, or thresholds, or a combination thereof. In some examples, the PDCCH parameters 458 stored at the network node 105 are the same as the PDCCH parameters 414 stored at the UE 115.

The transmitter 462 is configured to transmit reference signals, synchronization signals, control information, and data to one or more other devices, and the receiver 464 is configured to receive reference signals, control information and data from one or more other devices. For example, the transmitter 462 may transmit signaling, control information and data to, and the receiver 464 may receive signaling, control information and data from, the UE 115. In some implementations, the transmitter 462 and the receiver 464 may be integrated in one or more transceivers. Additionally, or alternatively, the transmitter 462 or the receiver 464 may include or correspond to one or more components of network node 105 described with reference to FIG. 2.

In some implementations, the wireless communication system 400 is configured to implement a 5G NR network or a 6G network. For example, the wireless communication system 400 may include multiple 5G-capable UEs 115 (or 6G-capable UEs 115) and multiple 5G-capable network nodes 105 (or 6G-capable network nodes 105), such as UEs and network nodes configured to operate in accordance with a 5G NR network protocol, or a 6G network protocol, such as that defined by the 3GPP.

In some 5G NR wireless networks, a total number of candidate DCI sizes that are monitored by UEs during performance of PDCCH blind detection procedures is small and is fixed across the various PDCCH blind detection procedures. Due to this restrictive DCI size limit, in many situations, a size of DCI that is generated by a network node is artificially increased or decreased, such as by zero padding or by truncating, respectively, to match one of the few candidate DCI sizes that are within the DCI size limit. The DCI size limit may be a small value due to a fixed PDCCH blind detection limit that is enforced on the UEs and other devices that perform PDCCH blind detection. To comply with the PDCCH blind detection limit, the UEs perform up to a particular number of blind detection operations, which includes both blind detection operations performed by the UEs on different PDCCH candidates and blind detection operations performed by the UEs on the same PDCCH candidates but for information having different DCI sizes. Accordingly, attempting to detect and decode DCI having two different DCI sizes on the same PDCCH candidate is considered two PDCCH blind detection operations. For this reason, a number of PDCCH blind detection operations that a UE or another device is expected to perform is at most k*(number of PDCCH candidates), where k is the number of candidate DCI sizes to be monitored by the UE or other device. Aspects described herein enable a configurable value of k while still complying with other limits such as a PDCCH blind detection limit or a non-overlapping CCE limit. As described further herein, k may be based on one or more other conditions or parameters associated with a PDCCH blind detection procedure, such as a number of PDCCH candidates to be monitored or a PDCCH blind detection mode (which may be associated with fewer PDCCH candidates for blind detection operations than for other operations).

During operation of the wireless communication system 400, the UE 115 may be configured with one or more control resource sets (CORESETs) by the network node 105. Each CORESET may be associated with one active transmission configuration indication (TCI) state, and as part of a CORESET configuration, resource blocks (RBs) of a CORESET in a frequency domain and a number of symbols of symbols of the CORESET may be configured by RRC messaging from the network node 105. Each of the one or more CORESETs may be associated with one or more search spaces (SS) sets, which are each a collection of PDCCH candidates that are to be blind detected by the UE 115 in certain monitoring occasions over a corresponding CORESET. For example, there can be up to ten SS sets in a BWP of a component carrier (CC). As part of a SS set configuration, the network node 105 may send RRC messaging to the UE 115 to configure one or more SS parameters. The SS parameters may include an SS set index, an SS set ID, an associated CORESET ID, or a combination thereof.

Additionally, or alternatively, the SS parameters may include an indication of monitoring slots periodicity, monitoring slots offset, and monitoring symbols within monitoring slots. Additionally, or alternatively, the SS parameters may include an SS set type, one or more DCI formats or DCI sizes to monitor, and a number of PDCCH candidates for a given aggregation level, or a combination thereof. PDCCH candidates are defined as part of one or more SS set configurations by the network node 105. For example, a PDCCH candidate with a given aggregation level and a given candidate index may be defined in a given SS set.

To receive control information from the network node 105, the UE 115 may be configured to monitor PDCCH candidates in at least one SS set and perform channel estimation and then blind detection operations on the PDCCH candidates. The blind detection operations may include performing cyclic redundancy check (CRC) decoding on the PDCCH candidates using an ID associated with the UE 115. If one or more of the PDCCH candidates pass the CRC decoding, the one or more PDCCH candidates are identified as PDCCHs that contain DCI for the UE 115. The ID may be a type of radio network temporary identifier (RNTI), examples of which include a cell radio network temporary identifier (C-RNTI), a temporary cell radio network temporary identifier (TC-RNTI), a configured scheduling radio network temporary identifier (CS-RNTI), a system information radio network temporary identifier (SI-RNTI), a paging radio network temporary identifier (P-RNTI), a random access radio network temporary identifier (RA-RNTI), or another type of RNTI. As an example of CRC-encoded DCI that may be blind detected by the UE 115, the network node 105 may scramble the CRC of DCI in accordance with a C-RNTI for a unicast PDCCH to RRC-connected UE.

Performing the channel estimation and the CRC decoding on each of a set of PDCCH candidates associated with configured CORESETs may be referred to as performing a single-stage PDCCH blind detection procedure. There can be multiple search spaces for the UE 115 to monitor in one time slot, and to limit or prevent over dedication of resources to blind detection, a PDCCH blind detection limit and a non-overlapped CCE limit may be defined. The PDCCH blind detection limit represents a maximum number of blind detection operations to be performed by the UE 115 and the non-overlapped CCE limit represents a maximum number of CCEs covered by the blind detection operations. The PDCCH blind detection limit, the non-overlapped CCE limit, or both, may be preprogrammed at the UE 115 or indicated in signaling received from the network node 105. In some implementations, the PDCCH blind detection limit, the non-overlapped CCE limit, or both, are defined in a wireless communications standard, such as a 3GPP wireless communications standard. Thus, a number of blind detection operations and a number of covered non-overlapping CCEs may be predefined for the UE 115 and the network node 105.

In order to perform a PDCCH blind detection procedure, the UE 115 may identify the DCI size limit 406 in accordance with one or more conditions or parameters associated with the PDCCH blind detection procedure. The conditions or parameters may include the PDCCH blind detection mode indicated by the detection mode indicator 412, the PDCCH count 413 of PDCCH candidates, other conditions or parameters, or a combination thereof. Stated another way, the total number of the candidate DCI sizes 408 monitored by the UE 115 may depend on the number of PDCCH candidates that are expected to be detected and decoded as part of PDCCH blind detection (the PDCCH count 413) or the type of PDCCH blind detection being performed (the detection mode indicator 412). In some implementations, the UE 115 is configured to perform a single type of PDCCH blind detection procedure or to perform PDCCH blind detection operations for a single sized set of PDCCH candidates, and in such implementations, the configuration of the DCI size limit 406 is static.

In some other implementations in which the UE 115 is capable of operating in more than one PDCCH blind detection mode or performing PDCCH blind detection on multiple sizes of sets of PDCCH candidates, the UE 115 may identify the DCI size limit 406 from multiple possible DCI size limits in accordance with the detection mode indicator 412 or the PDCCH count 413. In such implementations, the configuration of the DCI size limit 406 is dynamic, such that the DCI size limit 406 may change in time periods between performance of PDCCH blind detection procedures (although the DCI size limit 406 may remain fixed during performance of a respective PDCCH blind detection procedure). In some such implementations, the DCI size limit 406 depends on whether the detection mode indicator 412 indicates that the UE 115 is operating in a single-stage PDCCH blind detection mode or whether the detection mode indicator 412 indicates that the UE 115 is operating in a multi-stage PDCCH blind detection mode. In some aspects, the multi-stage PDCCH blind detection mode corresponds to a two-stage PDCCH blind detection procedure or a procedure with more than two stages, where at least one stage includes the performance of operations on the PDCCH candidates 410 to filter the PDCCH candidates 410 from an initial set to a second set. The second set may include fewer PDCCH candidates than the first set. The operations performed during these stage(s) do not include blind detection operations, and instead may be based on other signal measurements or channel estimates, as non-limiting examples. After performance of these stage(s), the PDCCH candidates 410 are the second set having the second size, and thus the PDCCH count 413 of PDCCH blind detection operations represents the second size and not the first size of the initial list. As such, if the multi-stage PDCCH blind detection procedure and the single-stage PDCCH blind detection procedure described herein are performed on initial sets of PDCCH candidates having the same size, the number of blind detection operations performed during the multi-stage PDCCH blind detection procedure is typically less than the number of PDCCH blind detection operations performed during the single-stage PDCCH blind detection procedure.

In some implementations, a DCI size limit associated with the multi-stage PDCCH blind detection procedure may be greater than a DCI size limit associated with the single-stage PDCCH blind detection procedure. For example, the DCI size limit 406 may represent a first maximum number of the candidate DCI sizes 408 or a second maximum number of the candidate DCI sizes 408, where the first maximum number is associated with a single set of PDCCH candidates in accordance with the DCI size limit 406 being for a single-stage PDCCH blind detection mode, and where the second maximum number is associated with a second set of PDCCH candidates, which may be a filtered set of PDCCH candidates, in accordance with the DCI size limit 406 being for a multi-stage PDCCH blind detection mode. In this example, the second maximum number may be larger than the first maximum number, as the multi-stage PDCCH blind detection procedure may perform blind detection operations on fewer PDCCH candidates. Alternatively, the second maximum number may be the same as the first maximum number if the multi-stage PDCCH blind detection procedure performs blind detection operations on the same number of PDCCH candidates as the single-stage PDCCH blind detection procedure. If the second maximum number is larger than the first maximum number, more candidate DCI sizes may be monitored without exceeding the PDCCH blind detection limit during performance of the multi-stage PDCCH blind detection procedure, as compared to the single-stage PDCCH blind detection procedure.

If the detection mode indicator 412 indicates that the UE 115 is performing the single-stage PDCCH blind detection procedure, the UE 115 may identify the first maximum number as the DCI size limit 406. Alternatively, if the detection mode indicator 412 indicates that the UE 115 is performing the multi-stage PDCCH blind detection procedure, the UE 115 may identify the second maximum number as the DCI size limit 406. After identifying the DCI size limit 406, the UE 115 may identify or select the candidate DCI sizes 408 in accordance with the DCI size limit 406, such that the total number of the candidate DCI sizes 408 does not exceed the DCI size limit 406.

In some such implementations, the DCI size limit 406 depends on the number represented by the PDCCH count 413, e.g., the total number of PDCCH candidates on which blind detection operations are expected to be performed by the UE 115. In some aspects, a DCI size limit associated with a smaller number of PDCCH candidates may be greater than a DCI size limit associated with a larger number of PDCCH candidates. For example, if the PDCCH count 413 is within a first range, the DCI size limit 406 may represent a third maximum number of the candidate DCI sizes 408. However, if the PDCCH count 413 is within a second range that includes larger numbers than are included within the first range, the DCI size limit 406 may represent a fourth maximum number of the candidate DCI sizes 408 that is smaller than the third maximum number. As a non-limiting example, the fourth maximum number may be four DCI sizes, the second range may be twenty through one hundred PDCCH candidates, the third maximum number may be six DCI sizes, and the first range may be one through nineteen PDCCH candidates. If the PDCCH count 413 is within the first range, the UE 115 may identify the third maximum number as the DCI size limit 406. Alternatively, if the PDCCH count 413 is within the second range, the UE 115 may identify the fourth maximum number as the DCI size limit 406. After identifying the DCI size limit 406, the UE 115 may identify or select the candidate DCI sizes 408 in accordance with the DCI size limit 406, such that the total number of the candidate DCI sizes 408 does not exceed the DCI size limit 406.

In some implementations, the DCI size limit 406, one or more additional DCI size limits, one or more of the candidate DCI sizes 408, or a combination thereof, are preprogrammed at the UE 115 and the network node 105. For example, one or more predefined DCI size limit(s) one or more predefined candidate DCI size(s), or a combination thereof, may be preprogrammed at the UE 115 and the network node 105 by a service provider. In some such implementations, the predefined DCI size limit(s), the predefined candidate DCI size(s), or both, correspond to values specified in a wireless communications standard, such as a wireless communications standard specification promulgated by the 3GPP or another entity. As an example, the wireless communications standard may specify particular DCI sizes associated with various ranges of candidate PDCCHs, particular DCI sizes associated with various PDCCH blind detection procedures, particular candidate DCI sizes associated with various aspects of PDCCH blind detection procedures, or a combination thereof.

Additionally, or alternatively, the DCI size limit 406, one or more additional DCI size limits, one or more of the candidate DCI sizes 408, or a combination thereof, may be set by the network node 105 and communicated to the UE 115. For example, the network node 105 may select one or more predefined DCI size limit(s) one or more predefined candidate DCI size(s), or a combination thereof, based on information available to the network node 105, conditions of a wireless communication channel between the network node 105 and the UE 115, or other factors. In this example, the network node 105 may communicate the selected values to the UE 115, such as by transmitting a DCI size indicator 482 and/or additional indicators to the UE 115. To illustrate, the DCI size indicator 482 may indicate the DCI size limit 406, one or more DCI size limit(s) and parameters associated with the DCI size limit(s) (such as total number ranges of PDCCH candidates, PDCCH blind detection modes, or the like), one or more candidate DCI size(s) (and optionally parameters associated with the candidate DCI size(s)), one or more PDCCH candidate(s) (and optionally parameters associated with selecting or determining the PDCCH candidate(s)), other information, or a combination thereof.

The network node 105 may communicate the DCI size indicator 482 using a variety of messaging or signaling. As an example, the DCI size indicator 482 may include or correspond to, or be included within, a message sent by the network node 105 during an initialization process associated with establishment of a communication link between the UE 115 and the network node 105. In this example, an initialization message may include the DCI size indicator 482, initial values of one or more parameters, one or more other indicators, initialization information, or a combination thereof. The initialization message may include a CORESET or a SS configuration message or another type of initialization or configuration message. Such an initialization message may be transmitted by the network node 105 to begin an initialization process for establishment of the communication link, or the message may be sent in response to a message received from the UE 115. In such an example, configuration of the DCI size limit 406, the candidate DCI sizes 408, or both, is static or semi-static. As another example, the DCI size indicator 482 may include or correspond to, or be included within, a medium access control (MAC) control element (MAC-CE) sent by the network node 105 or DCI sent by the network node 105. In this example, the MAC-CE or the DCI may include the DCI size indicator 482, and the MAC-CE or DCI may be sent by the network node 105 at various times while the UE 115 is wirelessly connected to the network node 105. In such an example, configuration of the DCI size limit 406, the candidate DCI sizes 408, or both can be dynamic, such as based on a determination or trigger condition at the network node 105.

In some implementations, the network node 105 transmits the DCI size indicator 482 in accordance with information received from the UE 115. For example, the network node 105 may configure the DCI size limit 406 based on a capability of the UE 115 for monitoring multiple sets of candidate DCI sizes, information that indicates a power mode or power saving at the UE 115, other UE information, or a combination thereof. Additionally, or alternatively, the network node 105 may determine whether to operate using a fixed DCI size limit, such as associated with a legacy or single-stage PDCCH blind detection mode, or to operate using one of multiple DCI size limits, based on the information received from the UE 115. For example, in implementations in which the network node 105 does not send the DCI size indicator 482, the network node 105 may determine whether to operate using a fixed DCI size limit or using multiple DCI size limits based on the UE capability, the UE power mode, other information, or a combination thereof, similar to determining whether to transmit the DCI size indicator 482. As such, operations described below with reference to the network node 105 transmitting the DCI size indicator 482 may also apply to the network node 105 determining whether to operate using a fixed DCI size limit or using at least one of multiple DCI size limits.

In some implementations, the network node 105 transmits the DCI size indicator 482 in accordance with a DCI size limit capability of the UE 115. For example, the UE 115 may transmit capability information 474 to the network node 105 and, based on the capability information 474, the network node 105 may transmit an acknowledgement 476 to the UE 115. The capability information 474 may indicate a DCI size limit capability of the UE 115, also referred to as a multiple DCI size limit capability or a legacy DCI size limit capability. The DCI size limit capability indicates whether the UE 115 is capable of operating with a single fixed DCI size limit in all situations or whether the UE 115 is capable of operating with one or more DCI size limit(s) related to conditions such as a total number of PDCCH candidates or a PDCCH blind detection mode. If the capability information 474 indicates that the UE 115 is capable of operating with DCI size limit(s) related to PDCCH blind detection conditions, the network node 105 may transmit, in accordance with the detection mode indicator 412 or the PDCCH count 413, the acknowledgement 476 to indicate that the UE 115 is to identify the DCI size limit 406. If the network node 105 sets candidate DCI size limit(s), the network node 105 also transmits the DCI size indicator 482 in accordance with receiving the capability information 474. Alternatively, if the capability information 474 indicates that the UE 115 is not capable of operating with DCI size limit(s) related to PDCCH blind detection conditions, i.e., that the UE 115 is only capable of operating with a fixed DCI size, the network node 105 may transmit the acknowledgement 476 to indicate to the UE 115 to operate with the fixed DCI size. In this example, the network node 105 does not transmit the DCI size indicator 482.

Additionally, or alternatively, the network node 105 may transmit the DCI size indicator 482 in accordance with a low power mode of operation at the UE 115. For example, the UE 115 may, as part of transitioning to a low power mode (a “power saving” mode in which the UE 115 prioritizes power saving over supporting some functionality) such as an idle mode or a sleep mode, transmit a power mode indicator 478 to the network node 105. The power mode indicator 478 may indicate a power mode in which the UE 115 is operating, such as a low power operating mode, a normal/higher power operating mode, or another power operating mode. The power mode indicator 478 may be included in or correspond to a distinct message or signaling, or the power mode indicator 478 may be included in another message or signaling, such as a request to enter a low power mode or UCI. The network node 105 may transmit the DCI size indicator 482 in accordance with the power mode indicator 478. For example, if the power mode indicator 478 indicates that the UE 115 is in the low power mode, the network node 105 may transmit the DCI size indicator 482 to the UE 115 in accordance with receiving the power mode indicator 478, such as in implementations in which using one of multiple DCI size limits can reduce power consumption as compared to using the fixed DCI size limit. As another example, if the power mode indicator 478 indicates that the UE 115 is not in the low power mode, e.g., is in a standard or higher power mode, the network node 105 may refrain from sending the DCI size indicator 482 to the UE 115 in accordance with receiving the power mode indicator 478. The operation of the UE 115 and the network node 105 using a fixed DCI size limit or multiple DCI size limits in accordance with the power mode indicator 478 may be static or semi-static, such as if the UE 115 transmits the power mode indicator 478 during an initialization process for a communication link with the network node 105 or periodically. Alternatively, the operation of the UE 115 and the network node 105 using a fixed DCI size limit or multiple DCI size limits in accordance with the power mode indicator 478 may be dynamic, such as if the UE 115 transmits the power mode indicator 478 in an uplink MAC-CE, a PUCCH, UCI within a PUSCH, or a combination thereof.

In some implementations, in addition to or in the alternative to configuring the DCI size limit 406 at the UE 115, the network node 105 configures the UE 115 to perform a particular type of PDCCH blind detection procedure. For example, the network node 105 may transmit a blind detection mode indicator 480 to the UE 115 to cause the UE 115 to operate in a selected PDCCH blind detection mode. For example, the blind detection mode indicator 480 may indicate that the UE 115 is to operate in a multi-stage PDCCH blind detection mode and perform a multi-stage PDCCH blind detection procedure. Alternatively, the blind detection mode indicator 480 may indicate that the UE 115 is to operate in a single-stage PDCCH blind detection mode and perform a single-stage PDCCH blind detection procedure. In some implementations, the network node 105 transmits the blind detection mode indicator 480 and the DCI size indicator 482 as separate indications. Alternatively, the network node 105 may include the blind detection mode indicator 480 and the DCI size indicator 482 in the same message, or the DCI size indicator 482 may also operate as the blind detection mode indicator 480. For example, if the DCI size indicator 482 has a first value that indicates a DCI size limit that is associated with the multi-stage PDCCH blind detection procedure, the UE 115 may interpret the DCI size indicator 482 having the first value as an indication to operate in the multi-stage PDCCH blind detection mode. As another example, if the DCI size indicator 482 has a second value that indicates a DCI size limit that is associated with the single-stage PDCCH blind detection procedure, the UE 115 may interpret the DCI size indicator 482 having the second value as an indication to operate in the single-stage PDCCH blind detection mode.

In accordance with identifying the DCI size limit 406 and the candidate DCI sizes 408, the UE 115 may perform a PDCCH blind detection procedure in accordance with the detection mode indicator 412. For example, the UE 115 may operate in a multi-stage PDCCH blind detection mode in accordance with the detection mode indicator 412 indicating the multi-stage PDCCH blind detection procedure, which may be based on information preprogrammed at the UE 115 or the blind detection mode indicator 480. In this example, one or more stages of the multi-stage PDCCH blind detection procedure may cause the UE 115 to perform one or more operations on an initial set of PDCCH candidates to filter the initial set of PDCCH candidates to, or otherwise to generate, the PDCCH candidates 410, for PDCCH blind detection. As another example, the UE 115 may operate in a single-stage PDCCH blind detection mode in accordance with the detection mode indicator 412 indicating the single-stage PDCCH blind detection procedure, which may be based on information preprogrammed at the UE 115 or the blind detection mode indicator 480. In this example, the PDCCH candidates 410 may be an initial set of PDCCH candidates for PDCCH blind detection.

In some implementations, the UE 115 selects which PDCCH blind detection procedure to perform in accordance with one or more of the PDCCH parameters 414. For example, if one of the PDCCH parameters 414 has a first particular value, the UE 115 may perform the multi-stage PDCCH blind detection procedure. Alternatively, if the same one of the PDCCH parameters 414 has a second particular value, the UE 115 may perform the single-stage PDCCH blind detection procedure. The PDCCH parameters 414 which may influence the UE 115 to operate in a particular PDCCH blind detection mode may include subcarrier spacing, frequency range, frequency band, total number of actively monitored components, other parameters, or a combination thereof. As an illustrative example, if the subcarrier spacing associated with the PDCCH candidates 410 satisfies a threshold, the UE 115 may perform the multi-stage PDCCH blind detection procedure. Although described as the UE 115 determining which PDCCH blind detection procedure to perform in accordance with one or more of the PDCCH parameters 414, in other implementations, the network node 105 may determine whether to send the blind detection mode indicator 480 in accordance with one or more of the PDCCH parameters 458, in the same manner as described for the UE 115 and the PDCCH parameters 414.

In some implementations, the PDCCH candidates 410 may be constrained by one or more limits, alternatively referred to as a second set of parameters. For example, a total number of the PDCCH candidates 410 monitored by the UE 115 may be less than or equal to a PDCCH blind detection limit. As another example, a total number of non-overlapped CCE elements covered by the PDCCH candidates 410 may be less than or equal to a non-overlapped CCE limit. The PDCCH blind detection limit, the non-overlapped CCE limit, or both, may be preprogrammed at the UE 115 or received from signaling by the network node 105. In some implementations, the PDCCH blind detection limit, the non-overlapped CCE limit, or both, are specified in a wireless communications standard. In some implementations, these limits may apply to the initial set of the PDCCH candidates 410 if the single-stage PDCCH blind detection procedure is being performed, and these limits may apply to a filtered or reduced set of the PDCCH candidates 410 if the multi-stage PDCCH blind detection procedure is being performed. Alternatively, the limit(s) may include separate criteria for PDCCH candidates to be blindly detected and for total blind detection operations on the same PDCCH candidate with different DCI sizes over a certain time window.

As an illustrative example of a defined PDCCH candidate limit, a wireless communications standard may define a PDCCH candidate limit that represents a maximum number of PDCCH candidates to be blindly detected during a time period and a PDCCH blind detection limit that represents a maximum total number of blind detection operations (including operations on the same PDCCH candidate for different DCI sizes) to be performed during the time period. In this example, the DCI size limit 406 is set such that a number of the candidate DCI sizes 408 k multiplied by the PDCCH candidate limit does not exceed the PDCCH blind detection limit.

Alternatively, the network node 105 may determine the PDCCH candidate limit and the PDCCH blind detection limit, and the network node 105 may communicate the limits to the UE 115, such as via a CORESET or SS configuration message, a MAC-CE, DCI, or the like. In some implementations, there may be multiple of such limits that are defined for different PDCCH parameters, such as sub-carrier spacing, frequency range, frequency band, or the like. Additionally, or alternatively, more stringent limits may be applied when the UE 115 is operating in a power saving mode, as indicated by the power mode indicator 478.

The UE 115 and the network node 105 may identify the DCI size limit 406, the candidate DCI sizes 408, the PDCCH candidates 410, or a combination thereof, further in accordance with any of the above-described limits, such that selections comply with one or more blind detection rules or conditions. Any of these limits or candidates, in addition to a PDCCH blind detection mode, aspects of the PDCCH blind detection mode, or a combination thereof, may be identified further in accordance with the PDCCH parameters 414 and the PDCCH parameters 458. As an illustrative example, the UE 115 may identify the DCI size limit 406 in accordance with the PDCCH count 413 or the detection mode indicator 412, and in accordance with a product of the DCI size limit 406 and PDCCH count 413 satisfying the above-described PDCCH blind detection limit. Additionally, or alternatively, the UE 115 or the network node 105 may also identify the DCI size limit 406, the PDCCH blind detection limit, or both, further in accordance with a subcarrier spacing included in the PDCCH parameters 414 and the PDCCH parameters 458, a frequency range included in the PDCCH parameters 414 and the PDCCH parameters 458, a frequency band included in the PDCCH parameters 414 and the PDCCH parameters 458, others of the PDCCH parameters 414 and the PDCCH parameters 458, or a combination thereof.

During at least one stage of operating in either of the PDCCH blind detection modes, the UE 115 may perform blind detection operations on the PDCCH candidates 410, for each of the candidate DCI sizes 408, to attempt to identify a PDCCH 411 having a DCI size 409 via which the network node 105 is providing control information to the UE 115. Stated another way, successful performance of the PDCCH blind detection procedure identifies the DCI size 409 from among the candidate DCI sizes 408 and the PDCCH 411 from among the PDCCH candidates 410 as representing the downlink channel from the network node 105 that include control information for the UE 115. For example, the UE 115 may perform, for each PDCCH candidate of the PDCCH candidates 410, and for each candidate DCI size of the candidate DCI sizes 408 within the DCI size limit 406, a blind detection operation on the PDCCH candidate. As a particular example, if the candidate DCI sizes 408 include three DCI sizes and the PDCCH candidates 410 include four PDCCH candidates, the UE 115 may perform a total of twelve blind detection operations that three blind detection operations on each of the four PDCCH candidates for each of the three DCI sizes, such as a first blind detection operation on a first PDCCH candidate for a first DCI size, a second blind detection operation on the first PDCCH candidate for a second DCI size, a third blind detection operation on the first PDCCH candidate for a third DCI size, a fourth blind detection operation on a second PDCCH candidate for the first DCI size, a fifth blind detection operation on the second PDCCH candidate for the second DCI size, a sixth blind detection operation on the second PDCCH candidate for the third DCI size, and similar blind detection operations on a third and fourth PDCCH candidate. The number of blind detection operations performed by the UE 115 may match the PDCCH count 413.

Because the DCI size limit 406 can depend on the PDCCH count 413 or the detection mode indicator 412, the UE 115 may be able to monitor more candidate DCI sizes when fewer PDCCH candidates are being monitored, which can increase flexibility of DCI size alignment. For example, if more candidate DCI sizes can be monitored by the UE 115, a likelihood that the network node 105 will have to truncate DCI or pad DCI to fit a candidate DCI size is reduced, which allows more efficient DCI transmission by the network node 105. Additionally, the network node 105 may avoid artificially increasing a code rate for the DCI, which may reduce a signal to interference and noise ratio (SINR) and make decoding the DCI more difficult for the UE 115. Instead, the network node 105 may transmit the DCI at a lower coding rate, which the UE 115 may be able to decode using fewer decibels than if the code rate is increased.

The UE 115 may perform the blind detection operations on the PDCCH candidates 410, for each of the candidate DCI sizes 408, in order to detect and decode control information from the network node 105. The blind detection operations may include generating a channel estimation and attempting to decode the CRC of a hypothetical DCI in accordance with an ID associated with the UE 115, such as an RNTI. If a CRC decoding is successful, the UE 115 may identify the PDCCH candidate as a PDCCH 411 that represents a PDCCH 470 that is assigned to the UE 115 by the network node 105. The UE 115 may monitor the PDCCH 411/the PDCCH 470 to receive and decode control information, such as DCI 472, from the network node 105. The DCI 472 may have the DCI size 409 that is identified from one of the candidate DCI sizes 408, such as by successful performance of a blind detection operation on the PDCCH 411 for the DCI size 409. In some implementations, the UE 115 may terminate the PDCCH blind detection procedure in response to a successful blind detection operation on a PDCCH candidate. Alternatively, the UE 115 may continue performing the blind detection operations until a threshold number of completed blind detection operations occur or until blind detection is attempted on each of the PDCCH candidates 410.

As a result of successful performance of the PDCCH blind detection procedure, the UE identifies the PDCCH 411 and the DCI size 409. Unless a false positive occurs, the PDCCH 411 corresponds to the PDCCH 470 that is assigned to the UE 115 by the network node 105. Additionally, unless a false positive occurs, the network node 105 may generate the DCI 472 having the DCI size 456 that is within the DCI size limit 454, which correspond to the DCI size 409 and the DCI size limit 406, respectively, at the UE 115. The network node 105 sends the DCI 472 to the UE 115 within the PDCCH 470, and the UE 115 may receive and decode the DCI 472 in accordance with the ID associated with the UE 115. If the DCI 472 is the first control information sent to the UE 115, the DCI 472 may indicate resources associated with a UE-specific PDCCH for the UE 115. A UE-specific PDCCH refers to a PDCCH that is assigned to a single UE, as compared to a group common PDCCH that is assigned to multiple UEs.

Alternatively, if the PDCCH 470 is a UE-specific PDCCH, the DCI 472 may indicate resources associated with a PDSCH for the UE 115. The UE 115 may monitor the channel(s) indicated by the DCI 472 to receive additional DCI or downlink (DL) data from the network node 105.

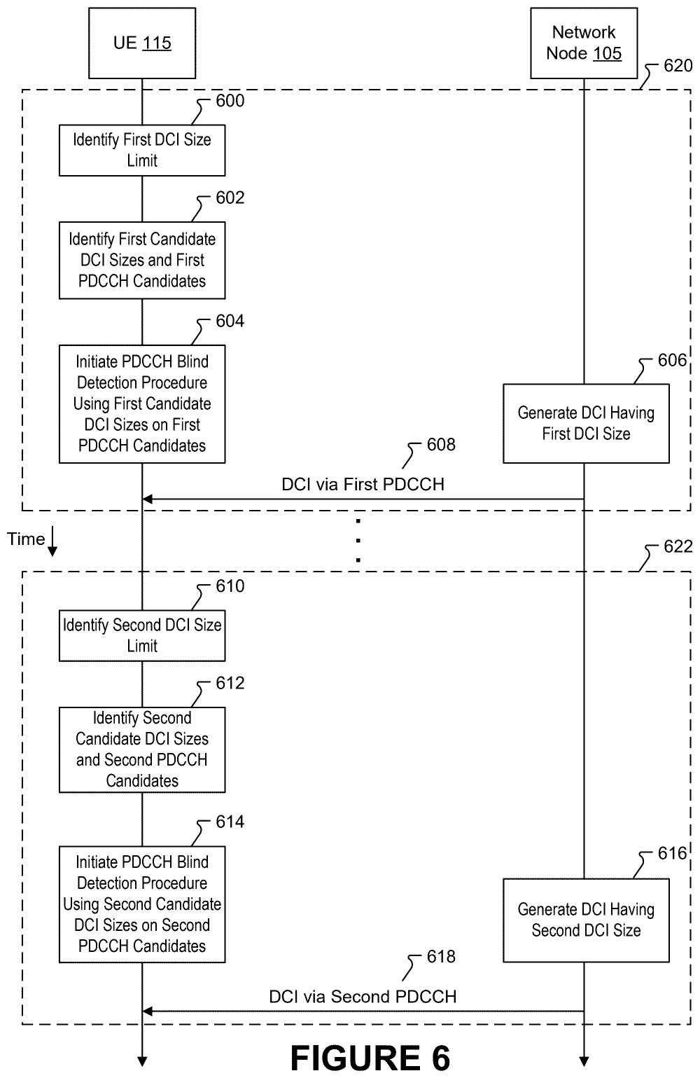

In some implementations, the DCI size limit 406 is static and only configured during an initialization process. In other implementations, the configuration of the DCI size limit 406, and thus the DCI size 409, can be semi-static or dynamic, and thus the UE 115 may transition from operating in accordance with the DCI size limit 406 to operating in accordance with a new DCI size limit. For example, after the UE 115 has received and processed the DCI 472 based on a first DCI size limit, the UE 115 may identify a new DCI size limit, such as based in a change in the number of the PDCCH candidates 410 or the PDCCH blind detection operating mode at the UE 115 or based on signaling from the network node 105. The UE 115 may perform blind decoding operations on the PDCCH candidates 410 in accordance with a new set of candidate DCI sizes that do not exceed the new DCI size limit. An example of changing DCI size limits at a subsequent time is further described herein with reference to FIG. 6.

As described with reference to FIG. 4, the present disclosure provides techniques for supporting a PDCCH blind detection procedure with a configurable number of DCI sizes. For example, the UE 115 may monitor a configurable number of the candidate DCI sizes 408 during performance of a PDCCH blind detection procedure, in contrast to typical PDCCH blind detection procedures in which a fixed number of DCI sizes are monitored for all conditions. In some aspects, different DCI size limits may be associated with different ranges of PDCCH candidates or different PDCCH blind detection modes, which can increase the number of the candidate DCI sizes 408 that are monitored by the UE 115 under certain conditions as compared to the other PDCCH blind detection procedures. For example, if a total number of the PDCCH candidates 410 is relatively small or if the UE 115 is operating in a multi-stage PDCCH blind detection mode, the DCI size limit 406 may be a larger number than a fixed number associated with other PDCCH blind detection procedures, and thus the UE 115 may be able to monitor a greater number of the candidate DCI sizes 408 while still complying with a PDCCH blind detection limit. Increasing the DCI size limit 406, and therefore the number of the candidate DCI sizes 408, may simplify DCI size alignment at the network node 105 as compared to having fewer DCI sizes. For example, increasing the number of the candidate DCI sizes 408 that are monitored by the UE 115 may reduce the likelihood that the network node 105 artificially increases or decreases a size of the DCI 472 to match one of the candidate DCI sizes 408, which can increase available bandwidth or throughput in the wireless communication system 400, and in some implementations, increase wireless communication performance between the network node 105 and the UE 115.

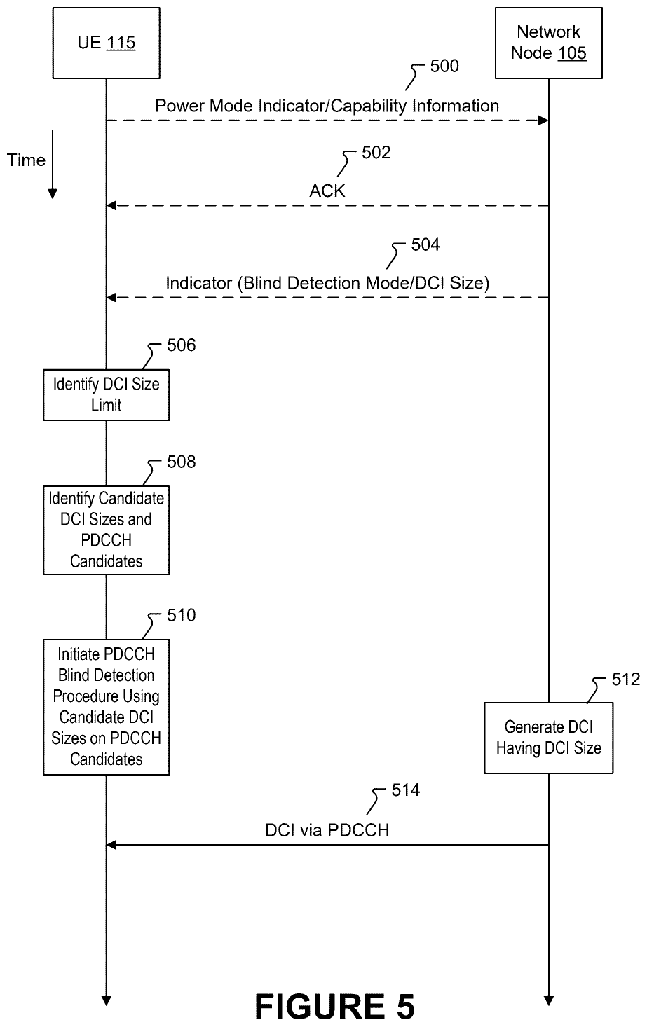

FIGS. 5-6 depict ladder diagrams illustrating various wireless communications to support various aspects of PDCCH blind detection procedures described herein. The operations described with reference to FIGS. 5-6 may be performed by the UE 115 and the network node 105 of FIGS. 1-4. Although operations are illustrated in FIGS. 5-6 as respective arrows and/or blocks, the operations described herein may be performed as a single operation or as multiple operations, and may include communication of one or more signals or messages to support the described functionality. Messages and signaling transmitted from the network node 105 to the UE 115 may be referred to as DL communications, and messages or signaling transmitted from the UE 115 to the network node 105 may be referred to as uplink (UL) communications. Additionally, or alternatively, although a particular order of operations is illustrated and described with reference to FIGS. 5-6, in other implementations, one or more operations may be performed in a different order or partially or wholly concurrently. Operations depicted using dashed lines are optional, and such operations may not be performed in some implementations described herein.

FIG. 5 is a ladder diagram illustrating example wireless communications that support a PDCCH blind detection procedure with a configurable number of DCI sizes in accordance with the present disclosure. In the example depicted in FIG. 5, the UE 115 optionally transmits a power mode indicator, capability information, or both, to the network node 105, at 500. For example, the UE 115 may transmit capability information to the network node 105, such as the capability information 474 of FIG. 4, to indicate that the UE 115 is capable of operating with a single fixed DCI size limit in all situations or whether the UE 115 is capable of operating with one or more DCI size limit(s) related to conditions such as a total number of PDCCH candidates or a PDCCH blind detection mode. Additionally, or alternatively, the UE 115 may transmit a power mode indicator to the network node 105, such as the power mode indicator 478 of FIG. 4, to indicate a power mode or power saving at the UE 115. In some implementations, various DCI size limits, candidate DCI sizes, or both, may be configured by the network node 105 for the UE 115 based on dynamic indication of power saving at the UE 115, as indicated by the power mode indicator.

The network node 105 optionally transmits an acknowledgement to the UE 115, at 502. In implementations in which the UE 115 sends the power mode indicator to the network node 105, the network node 105 may reply by sending an acknowledgement, such as the acknowledgement 476 of FIG. 4, to the UE 115. The acknowledgment may indicate that the network node 105 accepts a request by the UE 115 to enter the low power mode, that the network node 105 will send DCI having a DCI size that matches one of a set of candidate DCI sizes that is within a particular DCI size limit, other information, or a combination thereof.

The network node 105 optionally transmits a blind detection mode indicator, a DCI size indicator, or a combination thereof, to the UE 115, at 504. For example, the network node 105 may transmit a blind detection mode indicator to the UE 115, such as the blind detection mode indicator 480 of FIG. 4, to indicate whether the UE 115 is to operate in a multi-stage PDCCH blind detection mode (or a single-stage PDCCH blind detection mode). In implementations in which the network node 105 sends the blind detection mode indicator, the UE 115 may operate in a PDCCH blind detection mode represented by the blind detection mode indicator, such as by selecting a type of PDCCH blind detection procedure to perform in accordance with the indicator. As another example, the network node 105 may transmit a DCI size indicator to the UE 115, such as the DCI size indicator 482 of FIG. 4, to indicate a DCI size limit configured for the UE 115. In implementations in which the network node 105 sends the DCI size indicator, the UE 115 may identify a DCI size limit represented by the DCI size indicator for use during performance of a PDCCH blind detection procedure.

In some implementations, the network node 105 sends the blind detection mode indicator and the DCI size indicator to the UE 115 as separate and distinct indicators or messages. In some other implementations, the network node 105 sends a single indicator or message that represents the combined information of the blind detection mode indicator and the DCI size indicator. In aspects, the blind detection mode indicator, the DCI size indicator, or both, may be included in message(s) sent by the network node 105 during an initialization process associated with establishment of a communication link between the UE 115 and the network node 105 for a static or semi-static indication. Alternatively, the blind detection mode indicator, the DCI size indicator, or both, may be included in a MAC-CE or DCI sent by the network node 105 for a dynamic indication. In some implementations, a decision whether the UE 115 is to perform the multi-stage PDCCH blind detection procedure and/or a DCI size limit to be used by the UE 115 is decided at the network, such as based on channel parameters associated with a wireless channel between the network node 105 and the UE 115, scheduling of DCI for other UEs by the network node 105, or other information. Alternatively, the network node 105 may determine that the UE 115 is to perform the multi-stage PDCCH blind detection procedure, the DCI size limit to be used by the UE 115, or both, at least partially based on information or a request from the UE 115, such as in implementations in which the UE 115 sends the power mode indicator or the capability information.

The UE 115 identifies a DCI size limit that is associated with a number of PDCCH candidates that are expected to be decoded as part of a PDCCH blind detection procedure or a type of PDCCH blind detection procedure, at 506. The DCI size limit, such as the DCI size limit 406 of FIG. 4, represents a maximum number of candidate DCI sizes to be monitored by the UE 115 during performance of a PDCCH blind detection procedure. In some implementations, one or more DCI size limits are preprogrammed at the UE 115 and the network node 105, and the UE 115 may select one of the preprogrammed DCI size limit(s) in accordance with one or more conditions or parameters associated with a PDCCH blind detection procedure, such as a PDCCH blind detection mode (which may be indicated by the detection mode indicator 412 of FIG. 4), a number of PDCCH candidates that are expected to be decoded (which may be represented by the PDCCH count 413 of FIG. 4), other conditions or parameters, or a combination thereof. In some other implementations, the UE 115 may receive signaling from the network node 105, such as an initialization message, a MAC-CE, DCI, or the like, that indicates a DCI size limit selected for the UE 115 by the network node 105. Similar to the UE 115, the network node 105 may select one of one or more preprogrammed DCI size limits in accordance with a PDCCH blind detection mode or a number of expected PDCCH candidates to be decoded. In some such implementations, the network node 105 identifies the DCI size limit or sends signaling to indicate the DCI size limit in accordance with the capability information and/or the power mode indicator received from the UE 115 at 500. In some aspects, the DCI size limit(s) that are preprogrammed at the UE 115, the network node 105, or both, are defined in a wireless communication standard, such as one promulgated by the 3GPP.

The UE 115 may identify one or more candidate DCI sizes and a set of PDCCH candidates, at 508. For example, the one or more candidate DCI sizes (such as the candidate DCI sizes 408 of FIG. 4), the set of PDCCH candidates (such as the PDCCH candidates 410 of FIG. 4), or both, may be indicated by a CORESET configuration or a SS configuration, or by other signaling received from the network node 105. In some implementations, the UE 115 may select a group of candidate DCI sizes from multiple groups in accordance with the DCI size limit, such that the total number of candidate DCI sizes in the selected group does not exceed the DCI size limit. In some implementations, the UE 115 identifies the candidate DCI sizes further in accordance with a blind detection limit, a non-overlapping CCE limit, other limitations, or a combination thereof. Additionally, or alternatively, the UE 115 may select the candidate DCI sizes, the PDCCH candidates, or both, in accordance with one or more PDCCH parameters, such as the PDCCH parameters 414 of FIG. 4, which may include subcarrier spacing, frequency bands, frequency ranges, or a combination thereof.

The UE 115 initiates performance of a PDCCH blind detection procedure in accordance with the candidate DCI sizes on the PDCCH candidates, at 510. For example, the UE 115 may perform, for each of the candidate DCI sizes, blind detection operations on at least one of the PDCCH candidates. The PDCCH blind detection procedure may be a multi-stage PDCCH blind detection procedure or a single-stage PDCCH blind detection procedure, in some implementations depending on the blind detection mode indicator sent by the network node 105 at 504. In some implementations in the UE 115 performs the multi-stage PDCCH blind detection procedure, the DCI size limit and the candidate DCI sizes may correspond to a later stage during which blind detection operations are performed, and not to an earlier stage during which other operations are performed. In some implementations, the UE 115 performs the PDCCH detection procedure further in accordance with one or more PDCCH parameters. For example, the UE 115 may perform a particular type of PDCCH blind detection procedure if the subcarrier spacing associated with a set of PDCCH candidates has a particular value or is within a particular range, if a frequency range associated with the set of PDCCH candidates is a particular range or within a particular group of ranges, if a frequency band associated with the set of PDCCH candidates is a particular band or within a particular group of bands, or a combination thereof.

During performance of the PDCCH blind detection procedure, the UE 115 performs blind detection operations on at least some of the PDCCH candidates for one or more of the candidate DCI sizes. For example, the UE 115 may perform, in accordance with there being three candidate DCI sizes, three blind detection operations for the different candidate DCI sizes on each of at least one of the PDCCH candidates. Performing the blind detection operations on a PDCCH candidate may include estimating a channel associated with the PDCCH candidate and attempting to descramble or decode a CRC portion of the PDCCH candidate using an identifier associated with the UE 115, such as a type of RNTI. Each blind detection operation may be performed for a hypothetical DCI having one of the candidate DCI sizes. To enable performance of the PDCCH blind detection procedure at the UE 115, the network node 105 may generate DCI having a selected DCI size that complies with the candidate DCI sizes identified at the UE 115, at 512, and the network node 105 may transmit the DCI via the PDCCH to the UE 115, at 514. Therefore, the UE 115 may perform blind detection operations on various combinations of DCI size and PDCCH candidate in an attempt to find the DCI size associated with the DCI sent by the network node 105 and the PDCCH candidate that matches the PDCCH via which the DCI is sent. If a CRC check is successful, the blind detection operation is referred to as a success, and the UE 115 receives and decodes the DCI or other control information within the PDCCH, at 514. If the CRC check is not successful, the blind detection operation is referred to as a failure, and the UE 115 continues to perform blind detection operations on other PDCCH candidates, using other DCI sizes, or both until successful completion of a blind detection operation. If each of the blind detection operations fails, the UE 115 may perform one or more operations to deal with an error condition or may initiate performance of a new PDCCH blind detection procedure.

FIG. 6 is a ladder diagram illustrating example wireless communications that support changing a number of DCI sizes permitted during a PDCCH blind detection procedure in accordance with the present disclosure. In the example depicted in FIG. 6, the UE 115 identifies a first DCI size limit, at 600, and the UE 115 identifies first candidate DCI sizes and first PDCCH candidates, at 602. The UE 115 may identify the first DCI size limit and the first PDCCH candidates for a first time period 620 that begins at or before 600. The UE 115 initiates performance of a multi-stage PDCCH blind detection procedure to identify a PDCCH having a first DCI size, at 604, the network node 105 generates DCI having the first DCI size at 606, and the network node 105 transmits the DCI via the first PDCCH to the UE 115, at 608. For example, the operations performed by the UE 115 at 600-604 and the operations performed by the network node 105 at 606-608 may include at least some of the operations described above with reference to FIG. 5.

During a second time period 622 that is subsequent to the first time period 620, the UE 115 identifies a second DCI size limit that is associated with the second time period 622, at 610. The second time period 622 may begin at or before 610 and correspond to a time period during which a DCI size limit associated with the UE 115, candidate DCI sizes associated with UE 115, PDCCH candidates associated with the UE 115, a PDCCH detection mode associated with the UE 115, or a combination thereof, may change from values used during the first time period 620. For example, the second DCI size limit identified during the second time period 622 may be different than the first DCI size limit identified during the first time period 620. The second DCI size limit represents a maximum number of candidate DCI sizes to be monitored by the UE 115 during performance of a PDCCH blind detection procedure during the second time period 622. In some implementations, the UE 115 may select, as the second DCI size limit, one of one or more preprogrammed DCI size limit(s) in accordance with one or more conditions or parameters associated with a PDCCH blind detection procedure, such as a PDCCH blind detection mode for the second time period 622, a number of PDCCH candidates that are expected to be decoded during the second time period 622, other conditions or parameters, or a combination thereof. In some other implementations, the UE 115 may receive signaling from the network node 105, such as an initialization message, a MAC-CE, DCI, or the like, that indicates the second DCI size limit. Similar to the UE 115, the network node 105 may select one of one or more preprogrammed DCI size limits as the second DCI size limit in accordance with a PDCCH blind detection mode for the second time period 622 or a number of expected PDCCH candidates to be decoded during the second time period 622. As described above with reference to FIGS. 4 and 5, the DCI size limit(s) that are preprogrammed at the UE 115, the network node 105, or both, may be defined in a wireless communication standard, such as one promulgated by the 3GPP.

The UE 115 may identify second candidate DCI sizes and a second set of PDCCH candidates, at 612. For example, the second candidate DCI sizes, the second set of PDCCH candidates, or both, may be indicated by a second CORESET configuration or a second SS configuration, or by other signaling received from the network node 105. In some implementations, the UE 115 may select a second group of candidate DCI sizes from multiple groups in accordance with the second DCI size limit, such that the total number of candidate DCI sizes in the second selected group does not exceed the second DCI size limit. In some implementations, the UE 115 identifies the second candidate DCI sizes further in accordance with the blind detection limit, the non-overlapping CCE limit, other limitations, or a combination thereof. Additionally, or alternatively, the UE 115 may select the second candidate DCI sizes, the second PDCCH candidates, or both, in accordance with one or more PDCCH parameters, such as the PDCCH parameters 414 of FIG. 4, which may include subcarrier spacing, frequency bands, frequency ranges, or a combination thereof.

The UE 115 performs a second PDCCH blind detection procedure in accordance with the second candidate DCI sizes on the second PDCCH candidates, at 614. For example, the UE 115 may perform, for each of the second candidate DCI sizes, blind detection operations on at least one of the second PDCCH candidates. The second PDCCH blind detection procedure may be a multi-stage PDCCH blind detection procedure or a single-stage PDCCH blind detection procedure. In some implementations in which the UE 115 performs the multi-stage PDCCH blind detection procedure, the second DCI size limit and the second candidate DCI sizes may correspond to a later stage during which blind detection operations are performed, and not to an earlier stage during which other operations are performed. In some implementations, the UE 115 performs the second PDCCH detection procedure further in accordance with one or more PDCCH parameters, such as a subcarrier spacing, a frequency range, a frequency band, other parameters, or a combination thereof.

During performance of the second PDCCH blind detection procedure, the UE 115 performs blind detection operations on at least some of the second PDCCH candidates for one or more of the second candidate DCI sizes. For example, the UE 115 may perform, in accordance with there being four second candidate DCI sizes, four blind detection operations for the different second candidate DCI sizes on each of at least one of the second PDCCH candidates. The network node 105 may select a second DCI size that complies with the second candidate DCI sizes identified at the UE 115, and the network node 105 may generate DCI having the second DCI size, at 616, and the network node 105 may transmit the DCI via the second PDCCH to the UE 115, at 618. If a CRC check performed by the UE 115 during the second PDCCH detection procedure is successful, the blind detection operation is referred to as a success, and the UE 115 receives and decodes the DCI, or other control information, within the second PDCCH and having the second DCI size. If the CRC check is not successful, the blind detection operation is referred to as a failure, and the UE 115 continues to perform blind detection operations on other second PDCCH candidates, using other second DCI sizes, or both until successful completion of a blind detection operation. If each of the blind detection operations fails, the UE 115 may perform one or more operations to deal with an error condition or may initiate performance of a new PDCCH blind detection procedure.

FIG. 7 is a flow diagram illustrating an example process 700 that supports a PDCCH blind detection procedure with a configurable number of DCI sizes in accordance with the present disclosure. Operations of the process 700 may be performed by a UE, such as the UE 115 described above with reference to FIGS. 1-6. For example, example operations (also referred to as “blocks”) of the process 700 may enable the UE to perform a PDCCH blind detection procedure with a configurable number of DCI sizes, according to some aspects of the present disclosure.

FIG. 8 is a block diagram of an example UE 800 that supports a PDCCH blind detection procedure with a configurable number of DCI sizes in accordance with the present disclosure. The UE 800 may be configured to perform operations, including the blocks of the process 700 described with reference to FIG. 7, to perform a PDCCH blind detection procedure with a configurable number of DCI sizes. In some implementations, the UE 800 includes the structure, hardware, and components shown and described with reference to the UE 115 of FIGS. 1-6. For example, the UE 800 includes the controller 280, which operates to execute logic or computer instructions stored in the memory 282, as well as controlling the components of the UE 800 that provide the features and functionality of the UE 800. The UE 800, under control of the controller 280, transmits and receives signals via wireless radios 801a-r and the antennas 252a-r. The wireless radios 801a-r include various components and hardware, as illustrated in FIG. 2 for the UE 115, including the modems 254 a-r, the MIMO detector 256, the receive processor 258, the transmit processor 264, and the TX MIMO processor 266.

As shown, the memory 282 may include the PDCCH blind detection manager 150, a DCI size limit 802, a set of PDCCH candidates 803, and candidate DCI sizes 804. Although illustrated in FIG. 8 as being included in the memory 282, in other implementations, the PDCCH blind detection manager 150 may be a separate component of the UE 800. The PDCCH blind detection manager 150 may be configured to manage one or more operations supporting a PDCCH blind detection procedure with a configurable number of DCI sizes, such as identifying the DCI size limit 802, performing blind detection operations on the PDCCH candidates 803 in accordance with the candidate DCI sizes 804, or a combination thereof. The DCI size limit 802 may include or correspond to the DCI size limit 406 of FIG. 4. The set of PDCCH candidates 803 may include or correspond to the PDCCH candidates 410 of FIG. 4. The candidate DCI sizes 804 may include or correspond to the candidate DCI sizes 408 of FIG. 4. The UE 800 may receive signals from or transmit signals to one or more network nodes, such as the network node 105 of FIGS. 1-6 or a network node as illustrated in FIG. 10.

Referring back to the process 700 of FIG. 7, in block 702, the UE 800 identifies a DCI size limit associated with: a total number of PDCCH candidates of a set of PDCCH candidates, a PDCCH blind detection mode of a set of PDCCH blind detection modes, or a combination thereof. For example, the DCI size limit may include or correspond to the DCI size limit 406 of FIG. 4, the total number of PDCCH candidates may be represented by the PDCCH count 413 of FIG. 4, and the PDCCH blind detection mode may be represented by the detection mode indicator 412 of FIG. 4.

In block 704, the UE 800 performs, for each PDCCH candidate of the set of PDCCH candidates, and for each candidate DCI size of a set of candidate DCI sizes within the identified DCI size limit, a blind detection operation on the PDCCH candidate. For example, the set of PDCCH candidates may include or correspond to the PDCCH candidates 410 of FIG. 4, and the set of candidate DCI sizes may include or correspond to the candidate DCI sizes 408 of FIG. 4.

In block 706, the UE 800 receives, from a network node, control information via a PDCCH candidate of the set of PDCCH candidates in accordance with the performance of the blind detection operation on the PDCCH candidate. For example, the PDCCH candidate may include or correspond to the PDCCH 411 or PDCCH 470 of FIG. 4.

In some implementations, the DCI size limit represents a first maximum number of candidate DCI sizes associated with a single set of PDCCH candidates in accordance with the DCI size limit being for a single-stage PDCCH blind detection mode of the set of PDCCH blind detection modes or a second maximum number of candidate DCI sizes associated with a second set of PDCCH candidates in accordance with the DCI size limit being for a multi-stage PDCCH blind detection mode of the set of PDCCH blind detection modes. For example, the DCI size limit may represent the first maximum number of candidate DCI sizes or the second maximum number of candidate DCI sizes based on a value of the detection mode indicator 412 of FIG. 4. In some other implementations, the DCI size limit represents a third maximum number of candidate DCI sizes associated with a first grouping of PDCCH candidate sets in accordance with the total number of PDCCH candidates of the set of PDCCH candidates being within a first range or a fourth maximum number of candidate DCI sizes associated with a second grouping of PDCCH candidate sets in accordance with the total number of PDCCH candidates of the set of PDCCH candidates being within a second range. For example, the DCI size limit may represent the third maximum number of candidate DCI sizes or the fourth maximum number of candidate DCI sizes based on a value of the PDCCH count 413 of FIG. 4.

In some implementations, the DCI size limit is associated with a first time period, and the process 700 further includes the UE 800 identifying, for a second time period that is subsequent to the first time period, a subsequent DCI size limit and performing, for each PDCCH candidate of another set of PDCCH candidates, and for another set of candidate DCI sizes within the subsequent DCI size limit, an additional blind detection operation on the PDCCH candidate. The subsequent DCI size limit is different than the DCI size limit. An example of transitioning from using one DCI size limit to using a different DCI size limit during a later time period is described herein with reference to transitioning from the first time period 620 to the second time period 622 of FIG. 6.

In some implementations, the process 700 also includes the UE 800 identifying the DCI size limit in accordance with the total number of PDCCH candidates of the set of PDCCH candidates or the PDCCH blind detection mode, and such that a product of the DCI size limit and an expected total number of PDCCH candidates of the set of PDCCH candidates that are expected to be decoded satisfies a blind detection threshold. For example, the expected total number of PDCCH candidates may be represented by the PDCCH count 413 of FIG. 4, and the blind detection threshold may include or correspond to the PDCCH parameters 414 and the PDCCH parameters 458 of FIG. 4. In some such implementations, the process 700 further includes the UE 800 identifying the DCI size limit, the blind detection threshold, or both, further in accordance with a subcarrier spacing associated with the set of PDCCH candidates, a frequency range associated with the set of PDCCH candidates, a frequency band associated with the set of PDCCH candidates, or a combination thereof. For example, the subcarrier spacing, the frequency range, the frequency band, or a combination thereof, may include or correspond to the PDCCH parameters 414 and the PDCCH parameters 458 of FIG. 4.

In some implementations, the process 700 also includes the UE 800 transmitting, to the network node, capability information that indicates a DCI size limit capability of the UE and receiving, from the network node, an acknowledgement in accordance with the transmission of the capability information. In such implementations, the DCI size limit is identified in accordance with the acknowledgement. For example, the capability information may include or correspond to the capability information 474 of FIG. 4, and the acknowledgement may include or correspond to the acknowledgement 476 of FIG. 4. Additionally, or alternatively, the process 700 may also include the UE 800 transmitting, to the network node, an indication of a power saving mode at the UE. In such implementations, the DCI size limit is identified further in accordance with the power saving mode. For example, the indication may include or correspond to the power mode indicator 478 of FIG. 4.

FIG. 9 is a flow diagram illustrating an example process 900 that supports a PDCCH blind detection procedure with a configurable number of DCI sizes in accordance with the present disclosure. Operations of the process 900 may be performed by a network node, such as the network node 105 described above with reference to FIGS. 1-6. For example, example operations of the process 900 may enable a network node to perform a PDCCH blind detection procedure with a configurable number of DCI sizes, according to some aspects of the present disclosure.

FIG. 10 is a block diagram of an example network node 1000 that supports a PDCCH blind detection procedure with a configurable number of DCI sizes in accordance with the present disclosure. The network node 1000 may be configured to perform operations, including the blocks of the process 900 described with reference to FIG. 9, to perform a PDCCH blind detection procedure with a configurable number of DCI sizes. In some implementations, the network node 1000 includes the structure, hardware, and components shown and described with reference to the network node 105 of FIGS. 1-6. For example, the network node 1000 may include the controller 240, which operates to execute logic or computer instructions stored in the memory 242, as well as controlling the components of the network node 1000 that provide the features and functionality of the network node 1000. The network node 1000, under control of the controller 240, transmits and receives signals via wireless radios 1001a-t and the antennas 234a-t. The wireless radios 1001a-t include various components and hardware, as illustrated in FIG. 2 for the network node 105, including the modems 232a-t, the transmit processor 220, the TX MIMO processor 230, the MIMO detector 236, and the receive processor 238.

As shown, the memory 242 may include the PDCCH blind detection manager 152, a DCI size limit 1002, a DCI size 1003, and control information 1004. Although illustrated in FIG. 10 as being included in the memory 242, in other implementations, the PDCCH blind detection manager 152 may be a separate component of the network node 1000. The PDCCH blind detection manager 152 may be configured to manage one or more operations supporting a PDCCH blind detection procedure with a configurable number of DCI sizes, such as selecting the DCI size 1003 from a set of candidate DCI sizes having the DCI size limit 1002, transmitting the control information 1004 as DCI having the DCI size 1003, or a combination thereof. The DCI size limit 1002 may include or correspond to the DCI size limit 454 of FIG. 4. The DCI size 1003 may include or correspond to the DCI size 456 of FIG. 4. The control information 1004 may include or correspond to the DCI 472 of FIG. 4. The network node 1000 may receive signals from or transmit signals to one or more UEs, such as the UE 115 of FIGS. 1-6 or the UE 800 of FIG. 8.

Referring back to the process 900 of FIG. 9, in block 902, the network node 1000 selects, from a set of candidate DCI sizes within a DCI size limit, a DCI size. The DCI size limit is associated with a total number of physical downlink control channel (PDCCH) candidates of a set of PDCCH candidates, a PDCCH blind detection mode of a set of PDCCH blind detection modes, or a combination thereof. For example, the DCI size limit may include or correspond to the DCI size limit 454 of FIG. 4, the DCI size may include or correspond to the DCI size 456 of FIG. 4, the total number of PDCCH candidates may be represented by the PDCCH count 413 of FIG. 4, and the PDCCH blind detection mode may be represented by the detection mode indicator 412 of FIG. 4. In some implementations, a product of the DCI size limit and an expected total number of PDCCH candidates of the set of PDCCH candidates that are expected to be decoded satisfies a blind detection threshold. For example, the expected total number of PDCCH candidates may be represented by the PDCCH count 413 of FIG. 4, and the blind detection threshold may include or correspond to the PDCCH parameters 414 and the PDCCH parameters 458 of FIG. 4.

In block 904, the network node 1000 transmits, to a UE, control information via a PDCCH from the set of PDCCH candidates in accordance with the selected DCI size. For example, the control information may include or correspond to the DCI 472 of FIG. 4, and the PDCCH may include or correspond to the PDCCH 470 of FIG. 4.

In some implementations, the DCI size limit represents a first maximum number of candidate DCI sizes associated with a single set of PDCCH candidates in accordance with the DCI size limit being for a single-stage PDCCH blind detection mode of the set of PDCCH blind detection modes or a second maximum number of candidate DCI sizes associated with a second set of PDCCH candidates in accordance with the DCI size limit being for a multi-stage PDCCH blind detection mode of the set of PDCCH blind detection modes. For example, the DCI size limit may represent the first maximum number of candidate DCI sizes or the second maximum number of candidate DCI sizes based on a value of the detection mode indicator 412 of FIG. 4. In some other implementations, the DCI size limit represents a third maximum number of candidate DCI sizes associated with a first grouping of PDCCH candidate sets in accordance with the total number of PDCCH candidates of the set of PDCCH candidates being within a first range or a fourth maximum number of candidate DCI sizes associated with a second grouping of PDCCH candidate sets in accordance with the total number of PDCCH candidates of the set of PDCCH candidates being within a second range. For example, the DCI size limit may represent the third maximum number of candidate DCI sizes or the fourth maximum number of candidate DCI sizes based on a value of the PDCCH count 413 of FIG. 4.

In some implementations, the DCI size limit is associated with a first time period, and the process 900 further includes the network node 1000 selecting, for a second time period that is subsequent to the first time period, and from another set of candidate DCI sizes within a subsequent DCI size limit, a subsequent DCI size. In such implementations, the process 900 also includes the network node 1000 transmitting, to the UE, additional control information via a PDCCH from the set of PDCCH candidates in accordance with the subsequent DCI size. An example of transitioning from using one DCI size limit to using a different DCI size limit during a later time period is further described herein with reference to transitioning from the first time period 620 to the second time period 622 of FIG. 6.

In some implementations, the process 900 also includes the network node 1000 receiving, from the UE, capability information that indicates a DCI size limit capability of the UE and transmitting, to the UE, an acknowledgement in accordance with the capability information. For example, the capability information may include or correspond to the capability information 474 of FIG. 4, and the acknowledgement may include or correspond to the acknowledgement 476 of FIG. 4. Additionally, or alternatively, the process 900 may also include the network node 1000 receiving, from the UE, an indication of a power saving mode at the UE. The DCI size limit is selected further in accordance with the indication. For example, the indication may include or correspond to the power mode indicator 478 of FIG. 4.

It is noted that one or more blocks (or operations) described with reference to FIGS. 7 and 9 may be combined with one or more blocks (or operations) described with reference to another of the figures. For example, one or more blocks (or operations) of FIG. 7 may be combined with one or more blocks (or operations) of FIG. 9. As another example, one or more blocks associated with FIG. 7 or 9 may be combined with one or more blocks (or operations) associated with FIGS. 1-6. Additionally, or alternatively, one or more operations described above with reference to FIGS. 1-6 may be combined with one or more operations described with reference to FIG. 8 or 10.

In the following, further examples are described to facilitate the understanding of the disclosure.

According to Example 1, a UE for wireless communication includes a processing system that includes one or more processors and one or more memories coupled with the one or more processors, the processing system configured to cause the UE to: identify a DCI size limit associated with: a total number of PDCCH candidates of a set of PDCCH candidates, a PDCCH blind detection mode of a set of PDCCH blind detection modes, or a combination thereof; perform, for each PDCCH candidate of the set of PDCCH candidates, and for each candidate DCI size of a set of candidate DCI sizes within the identified DCI size limit, a blind detection operation on the PDCCH candidate; and receive, from a network node, control information via a PDCCH candidate of the set of PDCCH candidates in accordance with the performance of the blind detection operation on the PDCCH candidate.

Example 2 includes the UE of Example 1, wherein the DCI size limit represents: a first maximum number of candidate DCI sizes associated with a single set of PDCCH candidates in accordance with the DCI size limit being for a single-stage PDCCH blind detection mode of the set of PDCCH blind detection modes; or a second maximum number of candidate DCI sizes associated with a second set of PDCCH candidates in accordance with the DCI size limit being for a multi-stage PDCCH blind detection mode of the set of PDCCH blind detection modes.

Example 3 includes the UE of Example 1, wherein the DCI size limit represents: a third maximum number of candidate DCI sizes associated with a first grouping of PDCCH candidate sets in accordance with the total number of PDCCH candidates of the set of PDCCH candidates being within a first range; or a fourth maximum number of candidate DCI sizes associated with a second grouping of PDCCH candidate sets in accordance with the total number of PDCCH candidates of the set of PDCCH candidates being within a second range.

Example 4 includes the UE of any of Examples 1 to 3, wherein the DCI size limit is associated with a first time period, and wherein the processing system is further configured to cause the UE to: identify, for a second time period that is subsequent to the first time period, a subsequent DCI size limit, the subsequent DCI size limit being different than the DCI size limit; and perform, for each PDCCH candidate of another set of PDCCH candidates, and for another set of candidate DCI sizes within the subsequent DCI size limit, an additional blind detection operation on the PDCCH candidate.

Example 5 includes the UE of any of Examples 1 to 4, wherein the processing system is further configured to cause the UE to: identify the DCI size limit in accordance with the total number of PDCCH candidates of the set of PDCCH candidates or the PDCCH blind detection mode, and such that a product of the DCI size limit and an expected total number of PDCCH candidates of the set of PDCCH candidates that are expected to be decoded satisfies a blind detection threshold.

Example 6 includes the UE of Example 5, wherein the processing system is further configured to cause the UE to: identify the DCI size limit, the blind detection threshold, or both, further in accordance with a subcarrier spacing associated with the set of PDCCH candidates, a frequency range associated with the set of PDCCH candidates, a frequency band associated with the set of PDCCH candidates, or a combination thereof.

Example 7 includes the UE of any of Examples 1 to 6, wherein the processing system is further configured to cause the UE to: transmit, to the network node, capability information that indicates a DCI size limit capability of the UE; and receive, from the network node, an acknowledgement in accordance with the transmission of the capability information, and wherein the DCI size limit is identified in accordance with the acknowledgement.

Example 8 includes the UE of any of Examples 1 to 7, wherein the processing system is further configured to cause the UE to: transmit, to the network node, an indication of a power saving mode at the UE, and wherein the DCI size limit is identified further in accordance with the power saving mode.

According to Example 9, a method of wireless communication by a UE includes: identifying a DCI size limit associated with: a total number of PDCCH candidates of a set of PDCCH candidates, a PDCCH blind detection mode of a set of PDCCH blind detection modes, or a combination thereof; performing, for each PDCCH candidate of the set of PDCCH candidates, and for each candidate DCI size of a set of candidate DCI sizes within the identified DCI size limit, a blind detection operation on the PDCCH candidate; and receiving, from a network node, control information via a PDCCH candidate of the set of PDCCH candidates in accordance with the performance of the blind detection operation on the PDCCH candidate.

Example 10 includes the method of Example 9, wherein the DCI size limit represents: a first maximum number of candidate DCI sizes associated with a single set of PDCCH candidates in accordance with the DCI size limit being for a single-stage PDCCH blind detection mode of the set of PDCCH blind detection modes; or a second maximum number of candidate DCI sizes associated with a second set of PDCCH candidates in accordance with the DCI size limit being for a multi-stage PDCCH blind detection mode of the set of PDCCH blind detection modes.

Example 11 includes the method of Example 9, wherein the DCI size limit represents: a third maximum number of candidate DCI sizes associated with a first grouping of PDCCH candidate sets in accordance with the total number of PDCCH candidates of the set of PDCCH candidates being within a first range; or a fourth maximum number of candidate DCI sizes associated with a second grouping of PDCCH candidate sets in accordance with the total number of PDCCH candidates of the set of PDCCH candidates being within a second range.

Example 12 includes the method of any of Examples 9 to 11, wherein the DCI size limit is associated with a first time period, and the method further including: identifying, for a second time period that is subsequent to the first time period, a subsequent DCI size limit, the subsequent DCI size limit being different than the DCI size limit; and performing, for each PDCCH candidate of another set of PDCCH candidates, and for another set of candidate DCI sizes within the subsequent DCI size limit, an additional blind detection operation on the PDCCH candidate.

Example 13 includes the method of any of Examples 9 to 12, the method further including: identifying the DCI size limit in accordance with the total number of PDCCH candidates of the set of PDCCH candidates or the PDCCH blind detection mode, and such that a product of the DCI size limit and an expected total number of PDCCH candidates of the set of PDCCH candidates that are expected to be decoded satisfies a blind detection threshold.

Example 14 includes the method of Example 13, the method further including: identifying the DCI size limit, the blind detection threshold, or both, further in accordance with a subcarrier spacing associated with the set of PDCCH candidates, a frequency range associated with the set of PDCCH candidates, a frequency band associated with the set of PDCCH candidates, or a combination thereof.

Example 15 includes the method of any of Examples 9 to 14, the method further including: transmitting, to the network node, capability information that indicates a DCI size limit capability of the UE; and receiving, from the network node, an acknowledgement in accordance with the transmission of the capability information, and wherein the DCI size limit is identified in accordance with the acknowledgement.

Example 16 includes the method of any of Examples 9 to 15, the method further including: transmitting, to the network node, an indication of a power saving mode at the UE, and wherein the DCI size limit is identified further in accordance with the power saving mode.

According to Example 17, a network node for wireless communication includes a processing system that includes one or more processors and one or more memories coupled with the one or more processors, the processing system configured to cause the network node to: select, from a set of candidate DCI sizes within a DCI size limit, a DCI size, the DCI size limit being associated with: a total number of PDCCH candidates of a set of PDCCH candidates, a PDCCH blind detection mode of a set of PDCCH blind detection modes, or a combination thereof; and transmit, to a UE, control information via a PDCCH from the set of PDCCH candidates in accordance with the selected DCI size.

Example 18 includes the network node of Example 17, wherein the DCI size limit represents: a first maximum number of candidate DCI sizes associated with a single set of PDCCH candidates in accordance with the DCI size limit being for a single-stage PDCCH blind detection mode of the set of PDCCH blind detection modes; or a second maximum number of candidate DCI sizes associated with a second set of PDCCH candidates in accordance with the DCI size limit being for a multi-stage PDCCH blind detection mode of the set of PDCCH blind detection modes.

Example 19 includes the network node of Example 17, wherein the DCI size limit represents: a third maximum number of candidate DCI sizes associated with a first grouping of PDCCH candidate sets in accordance with the total number of PDCCH candidates of the set of PDCCH candidates being within a first range; or a fourth maximum number of candidate DCI sizes associated with a second grouping of PDCCH candidate sets in accordance with the total number of PDCCH candidates of the set of PDCCH candidates being within a second range.

Example 20 includes the network node of any of Examples 17 to 19, wherein the DCI size limit is associated with a first time period, and wherein the processing system is further configured to cause the network node to: select, for a second time period that is subsequent to the first time period, and from another set of candidate DCI sizes within a subsequent DCI size limit, a subsequent DCI size; and transmit, to the UE, additional control information via a PDCCH from the set of PDCCH candidates in accordance with the subsequent DCI size.

Example 21 includes the network node of any of Examples 17 to 20, wherein a product of the DCI size limit and an expected total number of PDCCH candidates of the set of PDCCH candidates that are expected to be decoded satisfies a blind detection threshold.

Example 22 includes the network node of any of Examples 17 to 21, wherein the processing system is further configured to cause the network node to: receive, from the UE, capability information that indicates a DCI size limit capability of the UE; and transmit, to the UE, an acknowledgement in accordance with the capability information.

Example 23 includes the network node of any of Examples 17 to 22, wherein the processing system is further configured to cause the network node to: receive, from the UE, an indication of a power saving mode at the UE, and wherein the DCI size limit is selected further in accordance with the indication.

According to Example 24, a method of wireless communication by a network node includes: selecting, from a set of candidate DCI sizes within a DCI size limit, a DCI size, the DCI size limit being associated with: a total number of PDCCH candidates of a set of PDCCH candidates, a PDCCH blind detection mode of a set of PDCCH blind detection modes, or a combination thereof; and transmitting, to a UE, control information via a PDCCH from the set of PDCCH candidates in accordance with the selected DCI size.

Example 25 includes the method of Example 24, wherein the DCI size limit represents: a first maximum number of candidate DCI sizes associated with a single set of PDCCH candidates in accordance with the DCI size limit being for a single-stage PDCCH blind detection mode of the set of PDCCH blind detection modes; or a second maximum number of candidate DCI sizes associated with a second set of PDCCH candidates in accordance with the DCI size limit being for a multi-stage PDCCH blind detection mode of the set of PDCCH blind detection modes.

Example 26 includes the method of Example 24, wherein the DCI size limit represents: a third maximum number of candidate DCI sizes associated with a first grouping of PDCCH candidate sets in accordance with the total number of PDCCH candidates of the set of PDCCH candidates being within a first range; or a fourth maximum number of candidate DCI sizes associated with a second grouping of PDCCH candidate sets in accordance with the total number of PDCCH candidates of the set of PDCCH candidates being within a second range.

Example 27 includes the method of any of Examples 24 to 26, wherein the DCI size limit is associated with a first time period, and the method further including: selecting, for a second time period that is subsequent to the first time period, and from another set of candidate DCI sizes within a subsequent DCI size limit, a subsequent DCI size; and transmitting, to the UE, additional control information via a PDCCH from the set of PDCCH candidates in accordance with the subsequent DCI size.

Example 28 includes the method of any of Examples 24 to 27, wherein a product of the DCI size limit and an expected total number of PDCCH candidates of the set of PDCCH candidates that are expected to be decoded satisfies a blind detection threshold.

Example 29 includes the method of any of Examples 24 to 28, the method further including: receiving, from the UE, capability information that indicates a DCI size limit capability of the UE; and transmitting, to the UE, an acknowledgement in accordance with the capability information.

Example 30 includes the method of any of Examples 24 to 29, the method further including: receiving, from the UE, an indication of a power saving mode at the UE, and wherein the DCI size limit is selected further in accordance with the indication.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-10 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logics, logical blocks, modules, circuits, and algorithm processes described in connection with the disclosure herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include random access memory (RAM), read-only memory (ROM), electronically erasable programable ROM (EEPROM), compact disc (CD) ROM (CD-ROM), or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product or a computer-readable storage device.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted can be incorporated in the example processes that are schematically illustrated. For example, one or more additional operations can be performed before, after, simultaneously with, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. Such a threshold may be a single value or a range of values. As an illustrative example, a value may satisfy a threshold range of values if the value is greater than or equal to each of the threshold values included in the threshold range of values.

No element, act, or instruction used herein should be construed as critical or essential unless explicitly described as such. Also, as used herein, the articles “a” and “an” are intended to include one or more items and may be used interchangeably with “one or more.” It should be understood that “one or more” is equivalent to “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Similarly, the phrase “in accordance with” is intended to mean “based on or otherwise in association with” unless explicitly stated otherwise.

The previous description of the disclosure is provided to enable any person skilled in the art to make or use the disclosure. Various modifications to the implementations described in this disclosure may be readily apparent to those skilled in the art, and the generic principles defined herein may be applied to other variations without departing from the scope of this disclosure. Thus, the disclosure is not intended to be limited to the examples and designs described herein but is to be accorded the widest scope consistent with the principles and novel features disclosed herein.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
identify a downlink control information (DCI) size limit associated with: a total number of physical downlink control channel (PDCCH) candidates of a set of PDCCH candidates, a PDCCH blind detection mode of a set of PDCCH blind detection modes, or a combination thereof;
perform, for each PDCCH candidate of the set of PDCCH candidates, and for each candidate DCI size of a set of candidate DCI sizes within the identified DCI size limit, a blind detection operation on the PDCCH candidate; and
receive, from a network node, control information via a PDCCH candidate of the set of PDCCH candidates in accordance with the performance of the blind detection operation on the PDCCH candidate.

2. The UE of claim 1, wherein the DCI size limit represents:
a first maximum number of candidate DCI sizes associated with a single set of PDCCH candidates in accordance with the DCI size limit being for a single-stage PDCCH blind detection mode of the set of PDCCH blind detection modes; or
a second maximum number of candidate DCI sizes associated with a second set of PDCCH candidates in accordance with the DCI size limit being for a multi-stage PDCCH blind detection mode of the set of PDCCH blind detection modes.

3. The UE of claim 1, wherein the DCI size limit represents:
a third maximum number of candidate DCI sizes associated with a first grouping of PDCCH candidate sets in accordance with the total number of PDCCH candidates of the set of PDCCH candidates being within a first range; or
a fourth maximum number of candidate DCI sizes associated with a second grouping of PDCCH candidate sets in accordance with the total number of PDCCH candidates of the set of PDCCH candidates being within a second range.

4. The UE of claim 1, wherein the DCI size limit is associated with a first time period, and wherein the processing system is further configured to cause the UE to:
identify, for a second time period that is subsequent to the first time period, a subsequent DCI size limit, the subsequent DCI size limit being different than the DCI size limit; and
perform, for each PDCCH candidate of another set of PDCCH candidates, and for another set of candidate DCI sizes within the subsequent DCI size limit, an additional blind detection operation on the PDCCH candidate.

5. The UE of claim 1, wherein the processing system is further configured to cause the UE to:
identify the DCI size limit in accordance with the total number of PDCCH candidates of the set of PDCCH candidates or the PDCCH blind detection mode, and such that a product of the DCI size limit and a total number of PDCCH candidates of the set of PDCCH candidates that are expected to be decoded satisfies a blind detection threshold.

6. The UE of claim 5, wherein the processing system is further configured to cause the UE to:
identify the DCI size limit, the blind detection threshold, or both, further in accordance with a subcarrier spacing associated with the set of PDCCH candidates, a frequency range associated with the set of PDCCH candidates, a frequency band associated with the set of PDCCH candidates, or a combination thereof.

7. The UE of claim 1, wherein the processing system is further configured to cause the UE to:
transmit, to the network node, capability information that indicates a DCI size limit capability of the UE; and
receive, from the network node, an acknowledgement in accordance with the transmission of the capability information, and wherein the DCI size limit is identified in accordance with the acknowledgement.

8. The UE of claim 1, wherein the processing system is further configured to cause the UE to:
transmit, to the network node, an indication of a power saving mode of the UE, and wherein the DCI size limit is identified further in accordance with the power saving mode.

9. A method of wireless communication by a user equipment (UE), comprising:
identifying a downlink control information (DCI) size limit associated with: a total number of physical downlink control channel (PDCCH) candidates of a set of PDCCH candidates, a PDCCH blind detection mode of a set of PDCCH blind detection modes, or a combination thereof;
performing, for each PDCCH candidate of the set of PDCCH candidates, and for each candidate DCI size of a set of candidate DCI sizes within the identified DCI size limit, a blind detection operation on the PDCCH candidate; and
receiving, from a network node, control information via a PDCCH candidate of the set of PDCCH candidates in accordance with the performance of the blind detection operation on the PDCCH candidate.

10. The method of claim 9, wherein the DCI size limit represents:
a first maximum number of candidate DCI sizes associated with a single set of PDCCH candidates in accordance with the DCI size limit being for a single-stage PDCCH blind detection mode of the set of PDCCH blind detection modes; or
a second maximum number of candidate DCI sizes associated with a second set of PDCCH candidates in accordance with the DCI size limit being for a multi-stage PDCCH blind detection mode of the set of PDCCH blind detection modes.

11. The method of claim 9, wherein the DCI size limit represents:
a third maximum number of candidate DCI sizes associated with a first grouping of PDCCH candidate sets in accordance with the total number of PDCCH candidates of the set of PDCCH candidates being within a first range; or
a fourth maximum number of candidate DCI sizes associated with a second grouping of PDCCH candidate sets in accordance with the total number of PDCCH candidates of the set of PDCCH candidates being within a second range.

12. The method of claim 9, wherein the DCI size limit is associated with a first time period, and further comprising:
identifying, for a second time period that is subsequent to the first time period, a subsequent DCI size limit, the subsequent DCI size limit being different than the DCI size limit; and
performing, for each PDCCH candidate of another set of PDCCH candidates, and for another set of candidate DCI sizes within the subsequent DCI size limit, an additional blind detection operation on the PDCCH candidate.

13. The method of claim 9, further comprising:
identifying the DCI size limit in accordance with the total number of PDCCH candidates of the set of PDCCH candidates or the PDCCH blind detection mode, and such that a product of the DCI size limit and an expected total number of PDCCH candidates of the set of PDCCH candidates that are expected to be decoded satisfies a blind detection threshold.

14. The method of claim 13, further comprising:
identifying the DCI size limit, the blind detection threshold, or both, further in accordance with a subcarrier spacing associated with the set of PDCCH candidates, a frequency range associated with the set of PDCCH candidates, a frequency band associated with the set of PDCCH candidates, or a combination thereof.

15. The method of claim 9, further comprising:
transmitting, to the network node, capability information that indicates a DCI size limit capability of the UE; and
receiving, from the network node, an acknowledgement in accordance with the transmission of the capability information, and wherein the DCI size limit is identified in accordance with the acknowledgement.

16. The method of claim 9, further comprising:
transmitting, to the network node, an indication of a power saving mode of the UE, and wherein the DCI size limit is identified further in accordance with the power saving mode.

17. A network node for wireless communication, comprising:
a processing system that includes one or more processors and one or more memories coupled with the one or more processors, the processing system configured to cause the network node to:
select, from a set of candidate downlink control information (DCI) sizes within a DCI size limit, a DCI size, the DCI size limit being associated with: a total number of physical downlink control channel (PDCCH) candidates of a set of PDCCH candidates, a PDCCH blind detection mode of a set of PDCCH blind detection modes, or a combination thereof; and
transmit, to a user equipment (UE), control information via a PDCCH from the set of PDCCH candidates in accordance with the selected DCI size.

18. The network node of claim 17, wherein the DCI size limit represents:
a first maximum number of candidate DCI sizes associated with a single set of PDCCH candidates in accordance with the DCI size limit being for a single-stage PDCCH blind detection mode of the set of PDCCH blind detection modes; or
a second maximum number of candidate DCI sizes associated with a second set of PDCCH candidates in accordance with the DCI size limit being for a multi-stage PDCCH blind detection mode of the set of PDCCH blind detection modes.

19. The network node of claim 17, wherein the DCI size limit represents:
a third maximum number of candidate DCI sizes associated with a first grouping of PDCCH candidate sets in accordance with the total number of PDCCH candidates of the set of PDCCH candidates being within a first range; or
a fourth maximum number of candidate DCI sizes associated with a second grouping of PDCCH candidate sets in accordance with the total number of PDCCH candidates of the set of PDCCH candidates being within a second range.

20. The network node of claim 17, wherein the DCI size limit is associated with a first time period, and wherein the processing system is further configured to cause the network node to:
select, for a second time period that is subsequent to the first time period, and from another set of candidate DCI sizes within a subsequent DCI size limit, a subsequent DCI size; and
transmit, to the UE, additional control information via a PDCCH from the set of PDCCH candidates in accordance with the subsequent DCI size.

21. The network node of claim 17, wherein a product of the DCI size limit and an expected total number of PDCCH candidates of the set of PDCCH candidates that are expected to be decoded satisfies a blind detection threshold.

22. The network node of claim 17, wherein the processing system is further configured to cause the network node to:
receive, from the UE, capability information that indicates a DCI size limit capability of the UE; and
transmit, to the UE, an acknowledgement in accordance with the capability information.

23. The network node of claim 17, wherein the processing system is further configured to cause the network node to:
receive, from the UE, an indication of a power saving mode at the UE, and wherein the DCI size limit is selected further in accordance with the indication.

24. A method of wireless communication by a network node, comprising:
selecting, from a set of candidate downlink control information (DCI) sizes within a DCI size limit, a DCI size, the DCI size limit being associated with: a total number of physical downlink control channel (PDCCH) candidates of a set of PDCCH candidates, a PDCCH blind detection mode of a set of PDCCH blind detection modes, or a combination thereof; and
transmitting, to a user equipment (UE), control information via a PDCCH from the set of PDCCH candidates in accordance with the selected DCI size.

25. The method of claim 24, wherein the DCI size limit represents:
a first maximum number of candidate DCI sizes associated with a single set of PDCCH candidates in accordance with the DCI size limit being for a single-stage PDCCH blind detection mode of the set of PDCCH blind detection modes; or
a second maximum number of candidate DCI sizes associated with a second set of PDCCH candidates in accordance with the DCI size limit being for a multi-stage PDCCH blind detection mode of the set of PDCCH blind detection modes.

26. The method of claim 24, wherein the DCI size limit represents:
a third maximum number of candidate DCI sizes associated with a first grouping of PDCCH candidate sets in accordance with the total number of PDCCH candidates of the set of PDCCH candidates being within a first range; or
a fourth maximum number of candidate DCI sizes associated with a second grouping of PDCCH candidate sets in accordance with the total number of PDCCH candidates of the set of PDCCH candidates being within a second range.

27. The method of claim 24, wherein the DCI size limit is associated with a first time period, and further comprising:
selecting, for a second time period that is subsequent to the first time period, and from another set of candidate DCI sizes within a subsequent DCI size limit, a subsequent DCI size; and
transmitting, to the UE, additional control information via a PDCCH from the set of PDCCH candidates in accordance with the subsequent DCI size.

28. The method of claim 24, wherein a product of the DCI size limit and an expected total number of PDCCH candidates of the set of PDCCH candidates that are expected to be decoded satisfies a blind detection threshold.

29. The method of claim 24, further comprising:
receiving, from the UE, capability information that indicates a DCI size limit capability of the UE; and
transmitting, to the UE, an acknowledgement in accordance with the capability information.

30. The method of claim 24, further comprising:
receiving, from the UE, an indication of a power saving mode at the UE, and wherein the DCI size limit is selected further in accordance with the indication.
